(19) United States
(12) Patent Application Publication
(10) Pub. No.: US 2013/0162905 A1
(43) Pub. Date: Jun. 27, 2013

(54) INFORMATION PROCESSING DEVICE, INFORMATION PROCESSING METHOD, PROGRAM, RECORDING MEDIUM, AND INFORMATION PROCESSING SYSTEM

(71) Applicant: SONY CORPORATION, Tokyo (JP)

(72) Inventors: Kyosuke MATSUMOTO, Tokyo (JP); Shusuke TAKAHASHI, Chiba (JP); Chisato KEMMOCHI, Kanagawa (JP); Akira INOUE, Tokyo (JP)

(73) Assignee: SONY CORPORATION, Tokyo (JP)

(21) Appl. No.: 13/719,652

(22) Filed: Dec. 19, 2012

(30) Foreign Application Priority Data
Dec. 26, 2011 (JP) 2011283817

(51) Int. Cl. H04N 5/06

(52) U.S. Cl. CPC H04N 5/06
USPC 348/521

(57) ABSTRACT

An information processing device includes a feature amount calculating unit configured to obtain an audio feature amount of audio included in a content including audio; a synchronization information generating unit configured to generate synchronization information for synchronizing a plurality of content including the same or similar audio signal components, based on the audio feature amount obtained by the feature amount calculating unit; and a compositing unit configured to generate composited content, where a plurality of contents have been synchronized and composited using the synchronization information generated at the synchronization information generating unit.

### BACKGROUND

The present technology relates to an information processing device, an information processing method, a program, a recording medium, and an information processing system, and more particularly relates to an information processing device, an information processing method, a program, a recording medium, and an information processing system, whereby, when compositing multiple contents, the multiple contents can be synchronized.

Recently, video sharing sites have come into popular use. With these video sharing sites, users can post contents which they have recorded including images (including moving images and still images) and audio (including voice and instrument sounds and the like) of themselves singing, dancing, playing instruments, and so forth (hereinafter also referred to as music performance contents). These video sharing sites allow the user to enjoy music performance contents that use various tunes.

Recently, as video sharing sites have gained widespread acceptance, so-called mashup is becoming popular where content is created by combining multiple music performance contents that use the same tune from the contents posted on the video sharing site, so that the performers of each of the multiple music performance contents appear to be performing together.

In order to mashup multiple music performance contents, the multiple music performance contents have to be synchronized therebetween (temporally). For example, Japanese Unexamined Patent Application Publication No. 2004-233698 describes a technique for compositing multiple contents as into a concerted sound source, assuming input of contents which have been synchronized beforehand. With the technique described in Japanese Unexamined Patent Application Publication No. 2004-233698, the user has to prepare multiple contents which have been synchronized, but preparing such contents is troublesome.

As for a method of preparing multiple contents which have been synchronized, there is a method of recording multiple contents while synchronizing, for example. As for a specific example for recording multiple contents while synchronizing, there are professional-level techniques, such as multi-viewpoint recording in television broadcasting stations, multi-channel recording for recording live performances, and so forth. However, it is extremely difficult for an end user to record multiple contents while synchronizing, using his/her own consumer-grade recording equipment, due to operability and capability related restrictions of the recording equipment.

Also, as for a method of preparing multiple contents which have been synchronized, there is a method where the user manually adds synchronization information to a content for synchronizing with other contents, for example, and this is the method currently used at video sharing sites and the like. However, manually adding synchronization information is troublesome, and further, precise synchronization can be difficult.

Also, even in the event that multiple contents with synchronization information added thereto could be prepared, changes to the contents themselves may render the synchronization information unusable. Specifically, upon editing such as cutting scenes, trimming, and so forth being performed on the contents, for example, the synchronization information added to the pre-editing contents may become useless.

Note that in the event of compressing (encoding) and decoding contents including moving images and audio accompanying the moving images, the audio may be out of synch with the moving images, and also similar loss of synchronization of audio may occur as to contents with synchronization information added, i.e., the audio may be out of synch with the timing which the synchronization information indicates.

### SUMMARY

In a case of attempting to composite multiple contents, as with mashup of multiple music performance contents including audio of various sound sources, the music performance contents to be used for the mashup are often not temporally synchronized.

It has been found desirable to enable compositing of multiple contents, not temporally synchronized beforehand, without temporal loss of synchronization.

With an information processing device according to an embodiment of the present technology, a program causing a computer to function as the information processing device, and a recording medium storing the program, the information processing device includes a feature amount calculating unit configured to obtain an audio feature amount of audio included in a content including audio; a synchronization information generating unit configured to generate synchronization information for synchronizing a plurality of contents including the same or similar audio signal components, based on the audio feature amount obtained by the feature amount calculating unit; and a compositing unit configured to generate composited content, where a plurality of contents have been synchronized and composited using the synchronization information generated at the synchronization information generating unit.

An information processing method according to an embodiment of the present technology includes: feature amount calculating to obtain an audio feature amount of audio included in a content including audio; synchronization information generating to generate synchronization information for synchronizing a plurality of contents including the same or similar audio signal components, based on the audio feature amount obtained in the feature amount calculating; and compositing to generate composited content, where a plurality of contents have been synchronized and composited using the synchronization information generated in the synchronization information generating.

An information processing system according to an embodiment of the present technology includes: a client; and a server configured to communicate with the client; wherein the server includes, of a feature amount calculating unit configured to obtain an audio feature amount of audio included in a content including audio, a synchronization information generating unit configured to generate synchronization information for synchronizing a plurality of contents including the same or similar audio signal components, based on the audio feature amount obtained by the feature amount calculating unit, and a compositing unit configured to generate composited content, where a plurality of contents have been synchronized and composited using the synchronization information generated at the synchronization information generating unit, at least the synchronization information generating unit, and wherein the client includes the remainder of the feature amount calculating unit, the synchronization information generating unit, and the compositing unit.

An information processing method according to an embodiment of the present technology, wherein a server, of an information processing system including a client and a server configured to communicate with the client, performs, of feature amount calculating to obtain an audio feature amount of audio included in a content including audio, synchronization information generating to generate synchronization information for synchronizing a plurality of contents including the same or similar audio signal components, based on the audio feature amount obtained in the feature amount calculating, and compositing to generate composited content, where a plurality of contents have been synchronized and composited using the synchronization information generated in the synchronization information generating, at least the synchronization information generating, and wherein the client performs the remainder of the feature amount calculating, the synchronization information generating, and the compositing.

According to the above configurations, an audio feature amount of audio included in a content including audio is obtained, and synchronization information for synchronizing a plurality of contents including the same or similar audio signal components is generated, based on the audio feature amount. Composited content is then generated, where a plurality of contents have been synchronized and composited using the synchronization information.

Note that the information processing device may be an independent device, or may be internal blocks configuring one device.

According to the present technology, audio signals of multiple contents which have not been temporally synchronized beforehand can be suitably temporally synchronized and composited.

As a result, temporal synchronization of contents, for example, does not have to be manually performed, so the user can easily enjoy synchronous playing of music performance contents such as mashup and so forth handling the same tune. Also, even with a content subjected to editing like cutting of scenes, trimming, and the like, or compression, a composited content composited by synchronizing multiple contents including that content can be generated. Further, synchronization information does not have to be manually added for example, so great amounts of a wide range of contents can be handled, and services can be enabled which provide composited contents to many users in cooperation with online moving image and audio sharing services and the like.

### BRIEF DESCRIPTION OF THE DRAWINGS

FIG. 1 is a block diagram illustrating a configuration example of a first embodiment of a content processing system to which the present technology has been applied;

FIG. 2 is a flowchart for describing content registration processing;

FIG. 3 is a flowchart for describing composited content providing processing;

FIG. 4 is a block diagram illustrating a configuration example of a feature amount calculating unit;

FIG. 5 is a flowchart for describing feature amount calculating processing;

FIG. 6 is a block diagram illustrating a configuration example of a synchronization related information generating unit;

FIG. 7 is a flowchart for describing synchronization related information generating processing;

FIG. 8 is a flowchart for describing selecting processing of independent content to be composited;

FIG. 9 is a flowchart for describing selecting processing of consecutive content to be composited;

FIG. 10 is a block diagram illustrating a configuration example of a compositing unit;

FIG. 11 is a flowchart for describing compositing processing;

FIG. 12 is a block diagram illustrating a first configuration example of an audio compositing unit;

FIG. 13 is a flowchart for describing audio compositing processing;

FIG. 14 is a block diagram illustrating a configuration example of an image compositing unit;

FIG. 15 is a flowchart for describing image compositing processing;

FIG. 16 is a block diagram illustrating a second configuration example of the audio compositing unit;

FIG. 17 is a flowchart for describing audio compositing processing;

FIG. 18 is a block diagram illustrating a third configuration example of the audio compositing unit;

FIG. 19 is a flowchart for describing audio compositing processing;

FIG. 20 is a block diagram illustrating a configuration example of a volume normalization coefficient calculating unit;

FIGS. 21A through 21D are diagrams for describing a method to cause volume of a common signal component included in a first audio and volume of a common signal component included in a second audio to match;

FIG. 22 is a flowchart for describing volume normalization coefficient calculating processing;

FIG. 23 is a block diagram illustrating a configuration example of an optimal volume ratio calculating unit;

FIG. 24 is a block diagram illustrating a first configuration example of a part estimating unit;

FIG. 25 is a block diagram illustrating a first configuration example of a volume ratio calculating unit;

FIG. 26 is a block diagram illustrating a second configuration example of the part estimating unit;

FIG. 27 is a flowchart for describing part estimating processing;

FIG. 28 is a block diagram illustrating a second configuration example of a volume ratio calculating unit;

FIG. 29 is flowchart for describing volume ratio calculating processing;

FIG. 30 is a block diagram illustrating a configuration example of a second embodiment of a content processing system to which the present technology has been applied;

FIG. 31 is a flowchart for describing processing at a client;

FIG. 32 is a flowchart for describing processing at the client;

FIG. 33 is a flowchart for describing processing at a server;

FIG. 34 is a flowchart for describing processing at the server;

FIG. 35 is a block diagram illustrating a configuration example of a third embodiment of a content processing system to which the present technology has been applied;

FIG. 36 is a flowchart for describing processing at the client;

FIG. 37 is a flowchart for describing processing at the server; and

FIG. 38 is a block diagram illustrating a configuration example of an embodiment of a computer to which the present technology has been applied.

### DETAILED DESCRIPTION OF EMBODIMENTS

First Embodiment of Content Processing System to which the Present Technique has been Applied

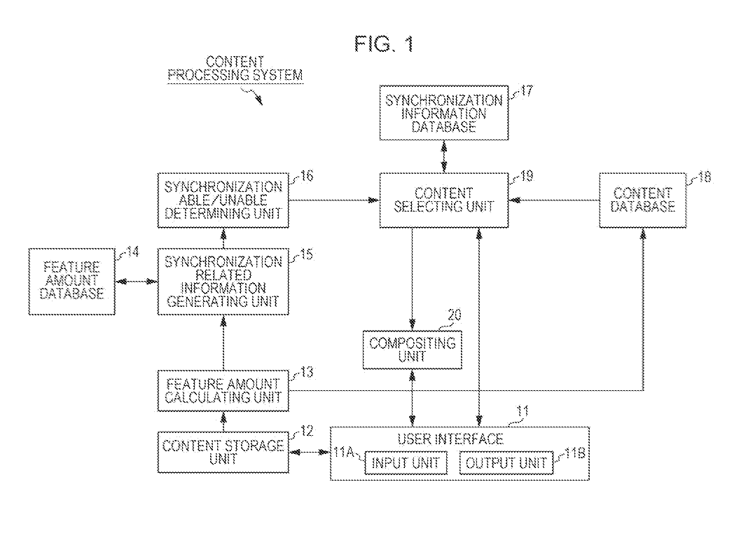

FIG. 1 is a block diagram illustrating a configuration example of a content processing system to which the present technique has been applied (here, the term “system” refers to multiple devices assembled logically, and it does not matter whether or not the devices of each configuration are in the same housing), according to a first embodiment.

In FIG. 1, an information processing system has a user interface 11, a content storage unit 12, a feature amount calculating unit 13, a feature amount database 14, a synchronization related information generating unit 15, a synchronization able/unable determining unit 16, a synchronization information database 17, a content database 18, a content selecting unit 19, and a compositing unit 20, and generates composited content composited from multiple contents.

The user interface 11 has an input unit 11A and an output unit 11B. The input unit 11A is configured with pointing devices such as a keyboard or a mouse, a touch screen, a microphone, and the like, and accepts input of operation or utterance from a user, for example. The user interface 11 performs various processing according to the operation and utterance which the input unit 11A has accepted. That is to say, for example, the user interface 11 controls the content storage unit 12 or content selecting unit 19 by sending various instructions (request) to the content storage unit 12 or content selecting unit 19 according to the operation which the input unit 11A has accepted.

The output unit 11B is configured, for example, with a display such as an LCD (Liquid Crystal Display), or a speaker or the like, for example, and displays an image and outputs audio. That is to say, for example, the output unit 11B performs playing of composited content supplied from compositing unit 20, where multiple contents are composited, that is to say, display of the images included in the composited content and output of audio included in the composited content.

The content storage unit 12 stores at least content including audio. Also, the content storage unit 12 selects content of interest from the stored contents according to the operations of the user interface 11 by a user and supplies to the feature amount calculating unit 13. For example, for the content storage unit 12, a hard disk, a video recorder, a video camera and the like can be adopted. Here, content including audio at least includes content being configured only with audio, and content being configured with images (moving images) and audio associated with the images, and the like.

The feature amount calculating unit 13 calculates an audio feature amount which is an audio feature amount included in the content of interest supplied from the content storage unit 12, and supplies this to the synchronization related information generating unit 15. Also, the feature amount calculating unit 13 supplies and registers (stores) the content of interest supplied from the content storage unit 12 to the content database 18 as appropriate.

Note that the audio feature amount of the content of interest (audio included therein) can adopt audio spectra or the like, for example. Also, the audio feature amount can adopt audio wave form itself (audio signal itself), for example. The feature amount database 14 stores audio feature amount supplied from the synchronization related information generating unit 15.

The synchronization related information generating unit generates synchronization related information related to synchronization with content of interest and content where the audio feature amount is registered in the feature amount database 14 (hereinafter, referred to as registered content), based on the audio feature amount of the content of interest from the feature amount calculating unit 13 and audio feature amount stored (registered) in the feature amount database 14, and supplies to the synchronization able/unable determining unit 16.

Also, the synchronization related information generating unit 15 supplies and registers the audio feature amount of the content of interest from the feature amount calculating unit 13 to the feature amount database 14 as appropriate. Note that the synchronization related information generating unit 15 generates synchronization related information with all contents (registered contents) where the audio feature amount is registered in the feature amount database 14 concerning the content of interest.

Also, the synchronization related information for content of interest and certain registered content includes synchronization information so as to synchronize audio with the content of interest and registered content, and a synchronizing able/unable level (index of the validity of the synchronizing) to represent the degree of possibility with which the audio can be synchronized with the content of interest and registered content.

The synchronization able/unable determining unit 16 includes a tune or the like that is the same or similar to audio signal components of the (audio of) content of interest, based on a synchronization able/unable level included in the synchronization related information from the synchronization related information generating unit 15, and as a result, determines whether or not synchronization of audio between the content of interest and registered content can occur.

The synchronization able/unable determining unit 16 supplies to the content selecting unit 19 a set (group) (information to identify) with the content of interest and registered content which has been determined to be synchronizable, along with the synchronization information included in synchronization related information with the content of interest and registered content from the synchronization related information generating unit 15.

The synchronization information database 17 correlates the synchronization information supplied from the content selecting unit 19 with information to identify the set of the content of interest, which is synchronized by the synchronization information thereof, and registered content.

The content database 18 stores the content of interest supplied from the feature amount calculating unit 13.

The content selecting unit 19 selects content to be composited, according to user operations, as the object of composited as to the composited content, from the contents stored in the content database 18, and supplies this to the compositing unit 20, along with the synchronization information for synchronization between these contents to be composited.

That is to say, for example, the content selecting unit 19 selects the contents regarding which the audio included in different contents can be synchronized as candidate contents to be a candidate of the content to be composited between the content of interest among contents stored in the content database 18.

Furthermore, the content selecting unit 19 generates a list screen or the like of titles and so forth of candidate content as an interface so as to enable the user to select content to be composited, which then supplies to the output unit 11B of the user interface 11 to be displayed.

When the (input unit 11A of) user interface 11 is operated so that a user sees a list screen and selects content to be composited from the candidate content, the content selecting unit 19 selects contents to be composited from the candidate contents according to the operation of the user interface 11 by the user.

Furthermore, the content selecting unit 19 reads out the (data of) contents to be composited from the content database 18 and also reads out the synchronization information (hereinafter referred to as synchronization information for compositing) to synchronize between contents to be composited from the synchronization information database 17, and supplies the contents to be composited and synchronization information for compositing to the compositing unit 20.

Also, the content selecting unit 19 correlates the synchronization information to synchronize the content of interest and registered content supplied from the synchronization able/unable determining unit 16 as appropriate, with the set with the content of interest and registered content (information to identify), and supplies and registers this to the synchronization information database 17.

The compositing unit 20 generates composited content composited after synchronizing content to be composited from the content selecting unit 19, using the synchronization information for compositing from the content selecting unit 19 in the same way, and supplies this to the user interface 11.

Note that, for the registered content which can be the content to be composited, for example, such recorded content adopted include a vocal (song), a musical instrument performance, a dance accompanied with a sound source of any tune, a karaoke version of any tune, or a sound source similar to the sound source of the any tune (the sound sources which has the same theme or of which accompaniment parts are similar), such as music performance content uploaded in the video sharing sites or the like.

For example, in the event that a certain registered content #1 and another registered content #2 are contents which use one sound source from among the predetermined tune, karaoke version of the predetermined tune, or the sound source similar to the sound source of the predetermined tune, then the sound source of the predetermined tune, the karaoke version of the predetermined tune, or the sound source similar to the sound source of the predetermined tune is included in the audio of the registered content #1 and audio of the registered content #2 as the same or similar audio signal components.

Let us say that these same or similar audio signal components are common signal components now and, with the content processing system in FIG. 1, (audio of) the content of interest and registered content are determined to be synchronizable in the case of including common signal components, and synchronization information of the content of interest which can be synchronized and the registered content is also generated using the common signal components.

Here, audio signals as common signal components can specify the point-in-time by observing the audio signals at a certain duration, wherein it is ideal to be a signal which can discriminate an audio signal at a different time, however is not particularly limited to such a signal.

With the content processing system configured in FIG. 1, content registration processing to register (data of) content in the content database 18 and composited content provision processing to provide composited content to users are performed.

Note that in the following, we will say that one or more contents (registered content) has been already stored in the content database 18 and the audio feature amount of all the registered contents stored in the content database 18 has been already stored in the feature amount database 14.

### Contents Registration Processing

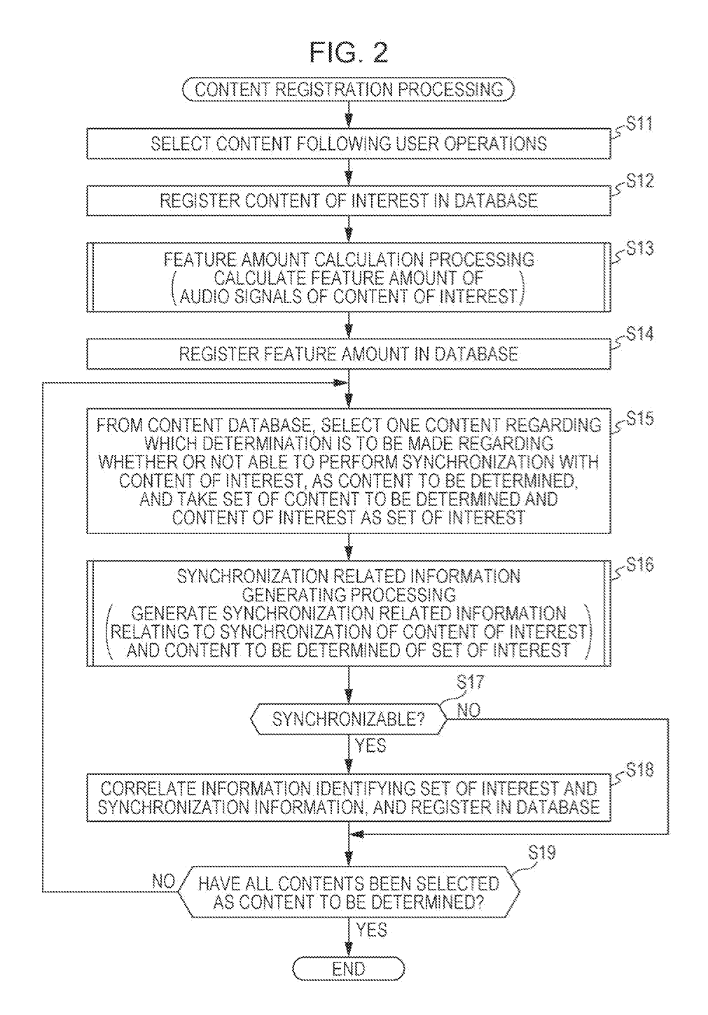

FIG. 2 is a flowchart illustrating the registered content registration processing where the content processing system in FIG. 1 performs.

In the content registration processing, in step S11, waits for a user operating the user interface 11, the content storage unit 12 selects the content of interest from the stored contents according to the operation of the user interface 11 by a user, and supplies this to the feature amount calculating unit 13, and the processing advances to step S12.

In step S12, the feature amount calculating unit 13 supplies and registers the content of interest supplied from the content storage unit 12 to the content database 18, and the processing advances to step S13.

In step S13, the feature amount calculating unit 13 performs feature amount calculation processing to calculate audio feature amount included in the audio of the content of interest from the content storage unit 12.

The feature amount calculating unit 13 supplies the audio feature amount of the content of interest obtained by the feature amount calculation processing to the synchronization related information generating unit 15, and the processing advances from step S13 to step S14.

In step S14, the synchronization related information generating unit 15 supplies and registers the audio feature amount of the content of interest from the feature amount calculating unit 13 to the feature amount database 14, and the processing advances to step S15.

In step S15, the synchronization related information generating unit 15 selects one of the contents which have not yet been selected as content to be determined, regarding which is determined the degree of possibility of synchronization with the content of interest, from the registered content (excluding the content of interest) stored in the content database 18.

Furthermore, the synchronization related information generating unit 15 creates a set with the content of interest and content to be determined as an set of interest content, and the processing advances from step S15 to step S16.

In step S16, the synchronization related information generating unit 15 performs synchronization related information generating processing to generate the synchronization related information related to the synchronization with the content of interest and content to be determined, based on the audio feature amount of the content of interest of the set of interest from the feature amount calculating unit 13 and the audio feature amount of the content to be determined of the set of interest stored in the feature amount database 14.

The synchronization related information generating unit supplies the synchronization related information of the set of interest of the content of interest and content to be determined, which is obtained by the synchronization related information, to the synchronization able/unable determining unit 16, and the processing advances from step S16 to step S17.

In step S17, with the synchronization able/unable determining unit 16, audio of the content to be determined of the set of interest includes a tune or the like which is the same or similar audio signal components as with (audio of) the content of interest of the set of interest, based on an able/unable level included in the synchronization related information of the set of interest from the synchronization related information generating unit 15, and as a result, performs a determination of whether or not synchronizing between the audio with the content of interest and content to be determined can be performed.

In step S17, in the event that the determination has been made that synchronizing (between the audio) of the content of interest and content to be determined can be performed, the processing advances to step S18, and the synchronization able/unable determining unit 16 supplies, information to identify the set of interest with the content of interest and registered content determined to be synchronizable, to the content selecting unit 19, along with the synchronization information included in the synchronization related information of the set of interest from the synchronization related information generating unit 15.

Furthermore, in step S18, the content selecting unit 19, correlates the synchronization information of the set of interest from the synchronization able/unable determining unit 16 with (information to identify) the set of interest from the synchronization able/unable determining unit 16 in the same way. The content selecting unit 19 then supplies and registers synchronization information of the set of interest thereof correlated with the set of interest to the synchronization information database 17, and the processing advances from step S18 to step S19.

On the other hand, in step S17, in the event of a determination having been made that synchronizing with the content of interest and registered content is unable to be performed, the processing skips step S18 and advances to step S19.

In step S19, the synchronization related information generating unit 15 determines whether or not all of registered contents stored in the content database 18 (excluding the content of interest) have been selected as content to be determined.

In step S19, in the event of a determination having been made that all of the registered content stored in the content database 18 (excluding the content of interest) has not yet been selected in the content to be determined, that is to say, in the event that there is content which is not selected in the content to be determined in the registered content (excluding the content of interest) stored in the content database 18, the processing returns to step S15, and similar processing is repeated as in the following.

Also, in step S19, in the event of determination having been made that all of the registered contents stored in the content database 18 (excluding the content of interest) has been selected as the content to be determined, that is to say, in the event that a determination is performed on whether or not the synchronization can be performed between all of the registered content stored in the content database 18 (excluding the content of interest) concerning the content of interest, and further the synchronization information to synchronize the registered content thereof concerning the registered content which are able to synchronize with the content of interest is registered in the synchronization information database 17, the processing ends.

### Composited Content Providing Processing

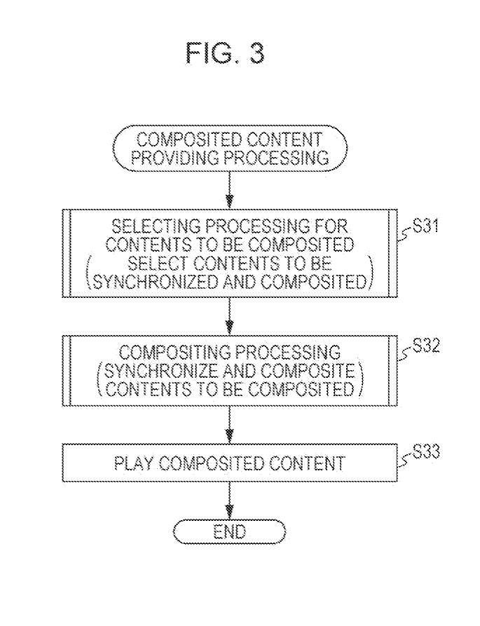

FIG. 3 is a flowchart illustrating composited content providing processing which the content processing system in FIG. 1 performs.

In the composited content providing processing, the content selecting unit 19 performs content to be composited selecting processing by selecting a plurality of contents to be used in compositing content generation as contents to be composited, from the registered contents stored in the content database 18, according to the user operation of the user interface 11 in step S31.

The content selecting unit 19 then reads out the synchronization information (synchronization information for compositing) to synchronize contents to be composited, obtained by content to be composited selecting processing from the synchronization information database 17, and supplies this to the compositing unit 20 with the contents to be composited, and the processing advances from step S31 to step S32.

In step S32, the compositing unit 20 performs compositing processing to generate composited content by synchronizing content to be composited from the content selecting unit 19 and compositing, using compositing synchronization information from the content selecting unit 19 in the same way.

The compositing unit 20 then supplies the composited content obtained by the compositing processing to the user interface 11, and the processing advances to step S33.

In step S33, the user interface 11 plays the composited content from the compositing unit 20, that is to say, performs display of the images included in the composited content and output of audio included in the composited content, and wherein composited content providing processing ends.

### Configuration Example of Feature Amount Calculating Unit 13

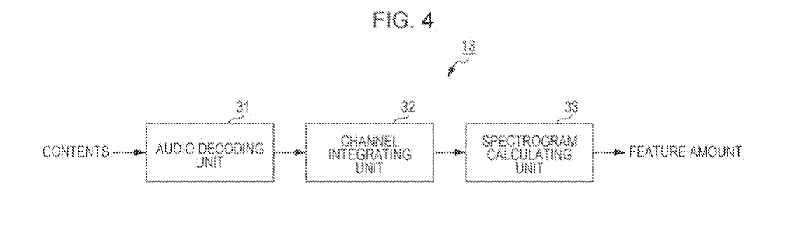

FIG. 4 is a block diagram illustrating a configuration example of the feature amount calculating unit 13 in FIG. 1. In FIG. 4, the feature calculating unit 13 has an audio decoding unit 31, a channel integrating unit 32, and a spectrogram calculating unit 33.

The data of content of interest is supplied to the audio decoding unit 31. In the event that audio included in the content of interest is encoded with encoded data, the audio decoding unit 31 decodes the encoded data thereof in audio and supplies this to the channel integrating unit 32. Note that in the event of audio included in the content of interest not being encoded, the audio decoding unit 31 supplies the audio included in the content of interest to the channel integrating unit 32 as it is.

The channel integrating unit 32 integrates audio of one channel by adding audio of the multiple channels in the event the audio from the audio decoding unit 31 multi-channel audio, and supplies this to the spectrogram calculating unit 33. Note that the channel integrating unit 32 supplies audio from the audio decoding unit 31 to the spectrogram calculating unit 33 as it is, in the event of audio from the audio decoding unit 31 is audio of one channel. The spectrogram calculating unit 33 calculates a spectrogram of audio from the channel integrating unit 32 and outputs as audio feature amount of the audio included in the content of interest.

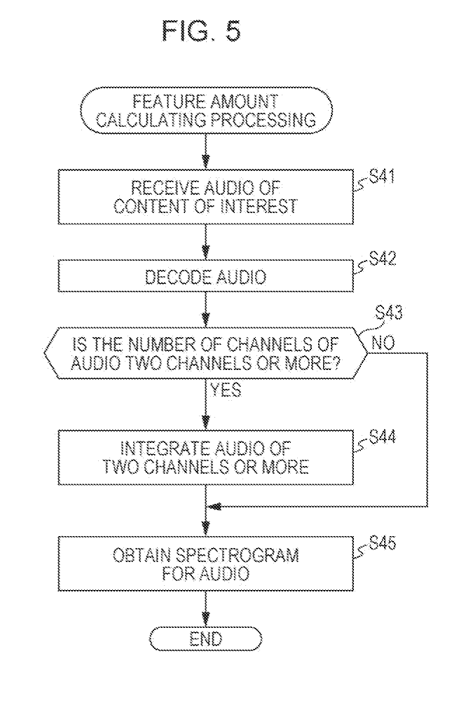

FIG. 5 is a flowchart illustrating feature amount calculating processing where the feature amount calculating unit 13 in FIG. 4 performs in step S13 of FIG. 2.

In the feature amount calculating unit 13, the audio decoding unit 31 receives (acquires) the content of interest from the content storage unit 12 (FIG. 1) in step S41, and the processing advances to step S42.

In step S42, the audio decoding unit 31 decodes audio included in the content of interest and supplies this to the channel integrating unit 32, and the processing advances to step S43.

In step S43, the channel integrating unit 32 determines whether or not the audio of the content of interest from the audio decoding unit 31 is audio of multiple channels.

In step S43, in the event that the audio of the content of interest is determined to be audio of multiple channels, the channel integrating unit 32 integrates the audio to one channel and supplies this to the spectrogram calculating unit 33 by adding audio of the content of interest from the audio decoding unit 31, that is to say, audio of multiple channels included in the content of interest, and the processing advances to step S45.

On the other hand, in step S43, in the event of a determination having been made that audio of the content of interest is not audio of multiple channels, that is to say, audio of the content of interest is audio of one channel, the channel integrating unit 32 supplies audio of the content of interest from the audio decoding unit 31 to the spectrogram calculating unit 33 as it is, and the processing skips step S44 and advances to step S45.

In step S45, the spectrogram calculating unit 33 calculates a spectrogram of audio from the channel integrating unit 32, and outputs as audio feature amount of the content of interest, and the feature amount calculating processing ends.

### Configuration Example of Synchronization Related Information Generating Unit 15

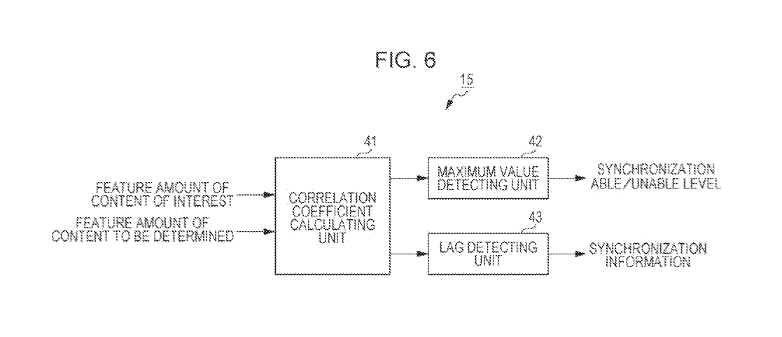

FIG. 6 is a block diagram illustrating a configuration example of a synchronization related information generating unit 15 in FIG. 1. In FIG. 6, the synchronization related information generating unit 15 has a correlation coefficient calculating unit 41, a maximum value detecting unit 42, and a lag detecting unit 43.

Audio feature amount of the content of interest of the set of interest is supplied to the correlation coefficient calculating unit 41 from the feature amount calculating unit 13 (FIG. 1), and the audio feature amount of the content to be determined from the set of interest is supplied from the feature amount database 14 (FIG. 1).

The correlation coefficient calculating unit 41 calculates a coefficient of cross-correlation with audio feature amount of the content of interest and audio feature amount of the content to be determined, and supplies this to the maximum value detecting unit 42 and lag detecting unit 43.

The maximum value detecting unit 42 detects a maximum value of a coefficient of cross-correlation of the set of interest supplied from the correlation coefficient calculating unit 41, that is to say, the maximum value of a coefficient of cross-correlation with audio feature amount of content of interest and audio feature amount of the content is determined, and this is output as a synchronization able/unable level (index of the validity of the synchronizing) representing the degree of possibility where audio with the content of interest and content to be determined as a set of interest can be synchronized.

The lag detecting unit 43 detects, the same as with the maximum value detecting unit 42, the maximum value of the coefficient of cross-correlation of the set of interest supplied from the correlation coefficient calculating unit 41, and outputs the amount of time out of synch (lag) between the audio feature amount of the content of interest and the audio feature amount of the content to be determined when the lag of the maximum value thereof, that is to say, the maximum value of the coefficient of cross-correlation with audio feature amount of the content of interest and the audio feature amount of the content to be determined, as synchronization information to synchronize audio with the content of interest and content to be determined.

A set with the synchronization able/unable level, which the maximum value detecting unit 42 outputs, and synchronization information, which the lag detecting unit 43 outputs, is supplied to the synchronization able/unable determining unit 16 (FIG. 1) as synchronization related information of the set of interest from the synchronization related information generating unit 15.

For example, both the content of interest and content to be determined include a part of, or all of the predetermined tune which is the same tempo, and in the event that the range of the tune included in one content of the content of interest and content to be determined corresponds with the range of the tune included in another content, or included in the range of the tune included in another content, the synchronization information which can synchronize audio with the content of interest and content to be determined can be generated by obtaining correlation with audio feature amount of the content of interest and the audio feature amount of content to be determined, such as the coefficient of cross-correlation.

Also, the lag of the maximum value of the coefficients of cross-correlation of the set of interest, detected as synchronization information at the lag detection unit 43 is one content of the content of interest and content to be determined, audio of the content of interest is, for example, the other content, and for example, represents being ahead or behind the audio of the content to be determined by the predetermined number of seconds.

Synchronizing audio of the content of interest and content to be determined can be enabled by starting playing of the content including audio of the one ahead by the predetermined number of seconds earlier by the predetermined number of seconds, of the content of interest and content to be determined, according to such synchronization information.

Note that in the event of adopting a lag of the maximum value of the coefficient of cross-correlation with the audio feature amount of the content of interest and the audio feature amount of the content to be determined (hereinafter, referred to as the maximum value lag) as synchronization information, the calculation of the coefficient of cross-correlation may be omitted regarding a part of the set of the two contents to be the content of interest and content to be determined.

That is to say, in the event that the information that “content #2 is ahead of content #1 by one second” has already been generated concerning contents #1, #2 and #3, as synchronization information #1-2 of audio of contents #1 and #2, and information that “content #3 is ahead of content #2 by two seconds” has also been generated, as synchronization information #2-3 of contents #2 and #3, instead of calculating the coefficient of cross-correlation of audio feature amount of contents #1 and #3, information that “content #3 is ahead of content #1 by three seconds” can be obtained using synchronization information #1-2 and #2-3.

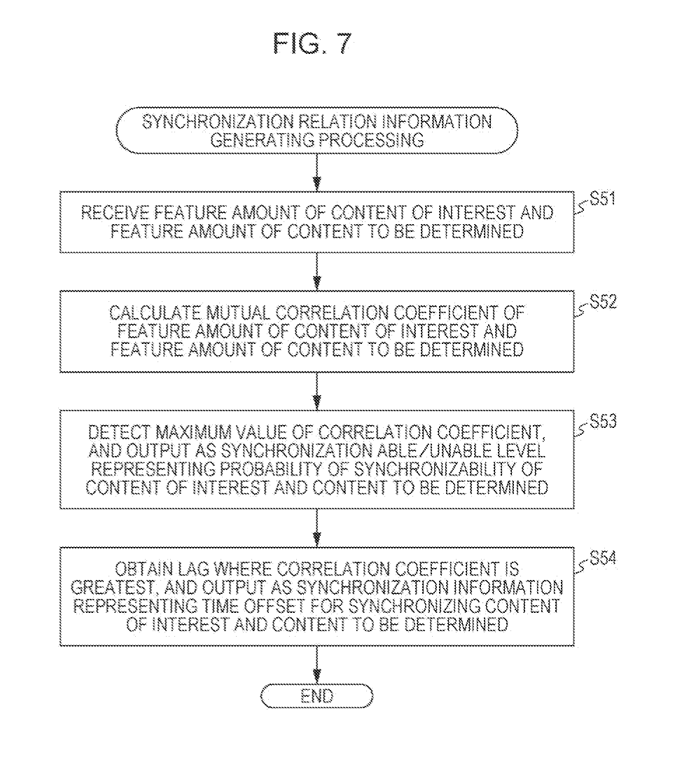

FIG. 7 is a flowchart describing the synchronization related information generation processing where the synchronization related information generating unit 15 in FIG. 6 performs in step S16 of FIG. 2.

In the synchronization related information generating unit 15, the correlation coefficient calculating unit 41 receives audio feature amount of the content of interest from the feature amount calculating unit 13 (FIG. 1) in step S51, and receives the audio feature amount of the content to be determined making up the set of interest with the content of interest from the feature amount database 14 (FIG. 1), and the processing advances to step S52.

In step S52, the correlation coefficient calculating unit 41 calculates the coefficient of cross-correlation with the audio feature amount of the content of interest and the audio feature amount of the content to be determined, and supplies this to the maximum value detecting unit 42 and lag detecting unit 43, and the processing advances to step S53.

In step S53, the maximum value detecting unit 42 detects the maximum value of the coefficient of cross-correlation from the correlation coefficient calculating unit 41, and outputs as synchronization able/unable level representing the degree of possibility where audio with the content of interest and content to be determined can be synchronized as the set of interest, and the processing advances to step S54.

In step S54, the lag detecting unit 43 detects the maximum value of the coefficient of cross-correlation from the correlation coefficient calculating unit 41 and detects a lag (maximum value lag) of the maximum value. The lag detecting unit 43 then outputs the maximum value lag as synchronization information representing the amount of time out of synch, to synchronize audio of the content of interest and content to be determined, and the synchronization related information generation processing ends.

Here, in the content processing system of FIG. 1, with the synchronization able/unable determining unit 16, content of interest as the set of interest, and audio of content to be determined including the same or similar audio signal components with the same tune common signal components, for example, based on the synchronization able/unable level of the set of interest where the maximum value detecting unit 42 outputs and as a result, determines whether or not synchronizing can be performed between the audio of each of the content of interest and content to be determined.

In the present embodiment, as a synchronization able/unable level, the maximum value of coefficients of cross-correlation, with audio feature amount of content of interest and audio feature amount of content to be determined, is adopted.

In the present embodiment, in the event that the maximum value of coefficients of cross-correlation, as synchronization able/unable level, is, for example, the predetermined threshold such as 0.6 or more, audio of the content of interest and content to be determined including the same or similar audio signal components (common signal components) such as the same tune, and a determination of the able/unable of synchronization will be made so that synchronizing with content of interest and content to be determined can be performed.

Note that the determination of the able/unable of synchronization between two contents may be performed based on the determination result of the able/unable of the synchronizing between two other contents, instead of the synchronization able/unable level.

That is to say, for example, when dealing with a content 1, content 2, and content 3, and concerning the relationship between content 1 and content 3, a judgment result regarding the degree of possibility of synchronization to the effect that synchronization can be performed, can be obtained by using the judgment result regarding the degree of possibility of synchronization for content 1 and content 2, and the judgment result regarding the degree of possibility of synchronization for content 2 and content 3 instead of the maximum value of the coefficient of cross-correlation (synchronization able/unable level) of content 1 and content 3 (audio feature amount), in the event that the judgment result regarding the degree of possibility of synchronization of to the effect that synchronization can be performed, is already obtained for content 1 and content 2, as well as the judgment result regarding the degree of possibility of synchronization to the effect that synchronization can be performed, is already obtained for content 2 and content 3.

As described above, the determination of the synchronization able/unable level between two contents, instead of the synchronization able/unable level, can be performed based on the determination result of another two contents, and the synchronization able/unable level, or coefficient of cross-correlation, can be omitted.

### Selecting Processing of Content to be Composited

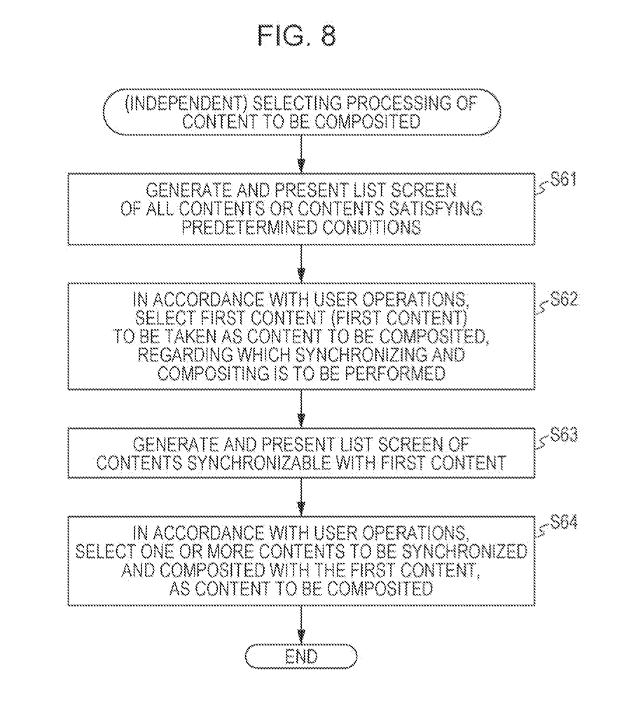

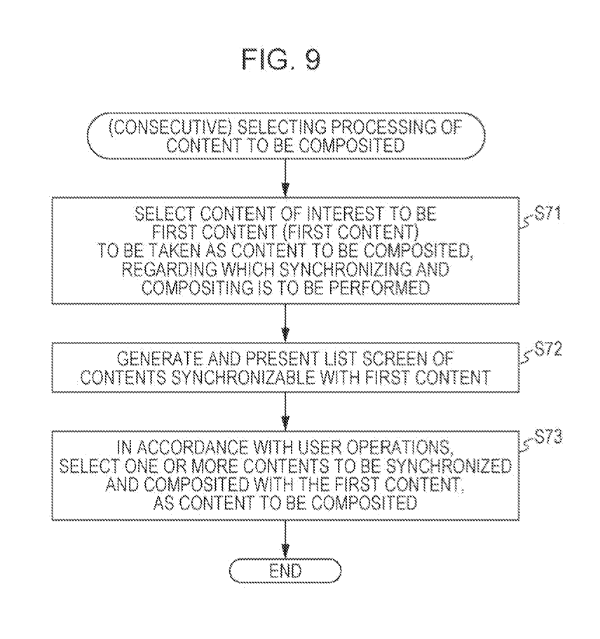

FIGS. 8 and 9 are flowcharts describing selecting processing of content to be composited where the content selecting unit 19 in FIG. 1 performs in step S31 in FIG. 3.

Here, the composited content providing processing of FIG. 3 can be performed in series, or can also be performed regardless of the content registration processing in FIG. 2, as processing following content registration processing, after the content registration processing in FIG. 2 has been performed according to user operation of the user interface 11 (FIG. 1), for example.

After the content registration processing of FIG. 2 has been performed as follows, selecting processing of content to be composited performed in series as processing following to the content registration processing, is referred to as continuous selecting processing of content to be composited, and selecting processing of content to be composited performed regardless of the content registration processing of FIG. 2 is referred to as independent selecting processing of content to be composited.

FIG. 8 is a flowchart describing independent selecting processing of content to be composited, and FIG. 9 is a flowchart describing continuous selecting processing of content to be composited.

In the independent selecting processing of content to be composited of FIG. 8, in step S61, the content selecting unit 19 generates a list screen of registered content all registered content stored in the content database 18 or registered content satisfying predetermined conditions, according to user operation of the user interface 11, for example, and presents to the user via display to the user interface 11, and the processing advances to step S62. Here, predetermined conditions to generate a list screen of the registered content satisfying predetermined conditions can be input by a user operating user interface 11.

In step S62, the content selecting unit 19 waits for the user who saw the list screen to operate user interface 11 so as to select one content on the list screen, and, according to the operation of the user interface 11, selects one content on the list screen as the first content which is content to be composited (hereinafter, referred to as first content), and the processing advances to step S63.

In step S63, the content selecting unit 19 selects, with reference to synchronization information database 17, content stored in the synchronization information database 17 with synchronization information for a first content, i.e., the contents which is able to synchronize with (audio of) the first content in the registered content as a candidate content which is a candidate of content to be composited.

Furthermore, the content selecting unit 19 generates a list screen (hereinafter referred to as candidate screen) of the candidate content and presents to a user via the user interface 11 display, and the processing advances from step S63 to step S64.

In step S64, the content selecting unit 19 waits for the user who saw the candidate screen to operate the user interface 11 so as to select one or more candidate contents on the list screen, and, according to the operation of the user interface 11, selects one or more contents on the candidate screen as the second and later content which is content to be composited, and the selecting processing of content to be composited ends.

In the independent selecting processing of content to be composited, as described above, one content (first content) selected from the list screen according to the operation of the user interface 11 in step S62 and one or more contents selected from the candidate screen according to the operation of the user interface 11 in step S64 becomes content to be composited.

Note that in FIG. 8, we had a user select all of registered content or the first content which is the content to be composited from the list screen of the registered content which satisfies predetermined conditions, and then had the user select one or more contents which is the content to be composited from the candidate screen of the candidate contents which are enabled to synchronize with the first content and otherwise, for example, the content selecting unit 19 generates the list of groups of the registered content which can synchronize, and can have a user select content to be composited from the list.

FIG. 9 is a flowchart for describing continuous selecting processing of content to be composited. In the continuous selecting processing of content to be composited, the content selecting unit 19 selects content of interest of the content registration processing in FIG. 2 as the first content (first content) as content to be composited in step S71, and the processing advances to step S72.

In step S72, the content selecting unit 19 selects, with reference to synchronization information database 17, content stored in the synchronization information database 17 with synchronization information for a first content, i.e., the contents which is able to synchronize with (audio of) the first content in the registered content as a candidate content which is a candidate of content to be composited.

Furthermore, the content selecting unit 19 generates a candidate screen which is a list screen of candidate content, and presents to a user via the user interface 11 display, and the processing advances from step S72 to step S73.

In step S73, the content selecting unit 19 waits for the user who saw the candidate screen to operate the user interface 11 so as to select one or more candidate contents on the list screen, and, according to the operation of the user interface 11, selects one or more contents on the candidate screen as the second and later content which is content to be composited, and the selecting processing of content to be composited ends.

In the continuous selecting processing of content to be composited, as described above, the content of interest and one or more contents selected from the candidate screen in step S73 become content to be composited according to the operation of the user interface 11.

### Configuration Example of Compositing Unit 20

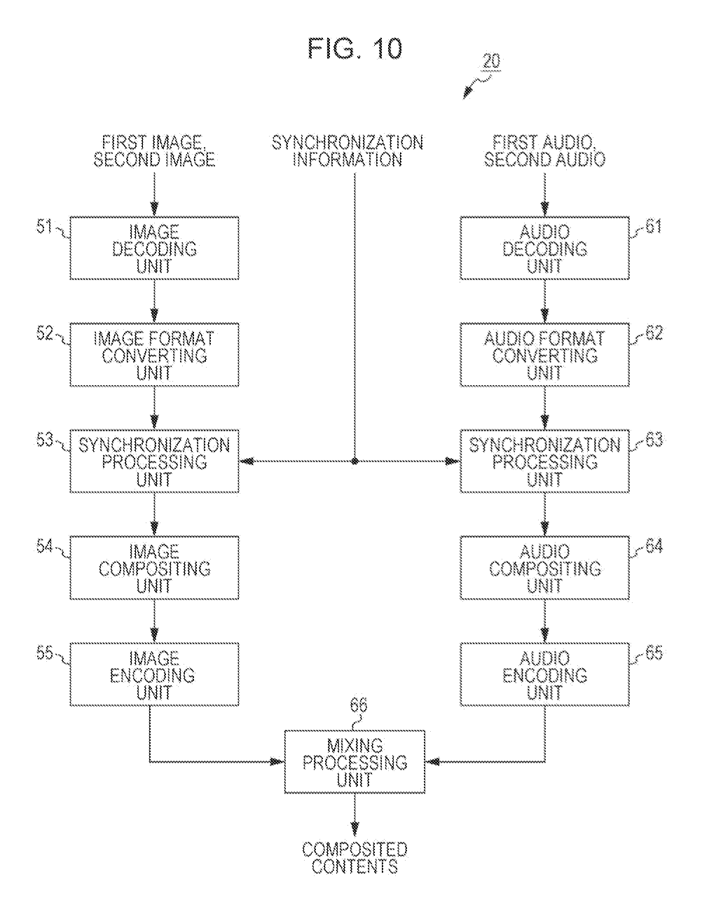

FIG. 10 is a block diagram illustrating a configuration example of the compositing unit 20 in FIG. 1. In FIG. 10, the compositing unit 20 has an image decoding unit 51, an image format converting unit 52, a synchronization processing unit 53, an image compositing unit 54, an image encoding unit 55, an audio decoding unit 61, an audio format converting unit 62, a synchronization processing unit 63, an audio compositing unit 64, an audio encoding unit 65, and a maxing processing unit 66. Using synchronization information for compositing from the content selecting unit 19, the compositing unit 20 synchronizes and composites content to be composited from the content selecting unit 19, thereby generating composited content.

For example, in the compositing unit 20, in the event that content to be composited is content of a vocal singing a predetermined tune, content of a part of a musical instrument playing a predetermined tune, and content of a dance being danced to a predetermined tune, such composited content can be obtained such that it appears that the performers in the content are conducting a joint performance.

Here, to make description simplified, two contents are supplied to the compositing unit 20 as content to be composited from the content selecting unit 19. Also, for an image and audio included in the first content which is the first content of the two contents to be composited, this is referred to as the first image and first audio, and for an image and audio included in the other content, which is the second content, this is referred to as the second image and second audio, respectively.

In the compositing unit 20 of FIG. 10, the first image and second image are supplied to the image decoding unit 51. The image decoding unit 51 decodes the first image and second image, and supplies to the image format converting unit 52.

The image format converting unit 52 performs format conversion which integrates into a format the first image and second image from the image decoding unit 51, i.e. for example, frame rate, size, and resolution, and supplies to the synchronization processing unit 53. Note that, in the format conversion in the image format converting unit 52, for example, an image format of the first image and second image can be converted into a format of which image quality is better than the other image format.

The first image and second image after format conversion, is supplied from the image format converting unit 52 to the synchronization processing unit 53, along with synchronization information (synchronization information for compositing) to synchronize each audio of the first content and second content from the content selecting unit 19 (FIG. 1) is supplied.

For example, the synchronization processing unit 53 synchronizes the first image and second image from the image format converting unit 52 according to the synchronization information for compositing, i.e., for example, such correction is performed that a timing of starting of play in either the first image or second image is shifted according to the synchronization information and the synchronized first image and second image which is obtained as a result, is supplied to the image compositing unit 54.

The image compositing unit 54 composites the first image and second image from the synchronization processing unit 53, for example, by arranging and placing in right and left or top and bottom, and supplies the composited image, which is composited of the first image and second image, to the image encoding unit 55. The image encoding unit 55 encodes the composited image from the image compositing unit 54 and supplies to the maxing processing unit 66.

The first audio and second audio are supplied to the audio decoding unit 61. The audio decoding unit 61 decodes the first audio and second audio and supplies to the audio format converting unit 62.

The audio format converting unit 62 converts to a format of the first audio and second audio from the audio decoding unit 61, i.e., for example, the format which integrates the number of quantization bits or a sampling rate, and supplies to the synchronization processing unit 63. Note that, with the format conversion in the audio format converting unit 62, for example, an audio format of either the first audio and second audio can be converted into a format of the other audio, where the audio quality of the audio format is better.

The first audio and second audio after the format conversion are supplied from the audio format converting unit 62 to the synchronization processing unit 63, along with synchronization information (synchronization information for compositing) to synchronize each audio of the first content and second content is supplied from the content selecting unit 19 (FIG. 1).

For example, the synchronization processing unit 63 synchronizes the first audio and second audio from the audio format converting unit 62 according to the synchronization information for compositing, i.e., for example, correction where timing of starting play of either the first audio or second audio is shifted in accordance with the synchronization information, and supplies the synchronized first audio and second audio which are obtained as a result, to the audio compositing unit 64.

The audio compositing unit 64 composites the first audio and second audio from the synchronization processing unit 63 for example, by adding every channel such as the left channel and right channel, and supplies the composited audio which is a composite of the first audio and second audio to the audio encoding unit 65.

Here, in the event that the first audio and second audio are audio of the same number of channels, such as with stereo audio or the like, in the audio compositing unit 64, the first audio and second audio are added per channel as described above, however in the event that the number of the channels of the first audio and second audio is different, for example, in audio compositing unit 64, mixing (downmixing) is performed to adjust the number of channels in either the first audio or the second audio to match that of the audio with the smaller number of channels.

The audio encoding unit 65 encodes composite audio from the audio compositing unit 64 and supplies to the mixing processing unit 66.

The mixing processing unit 66 performs mixing (integration) on the composited image from the image encoding unit 66 and the encoding results of the composited voice from the audio encoding unit 65 into one bit stream as composited content, and then outputs this.

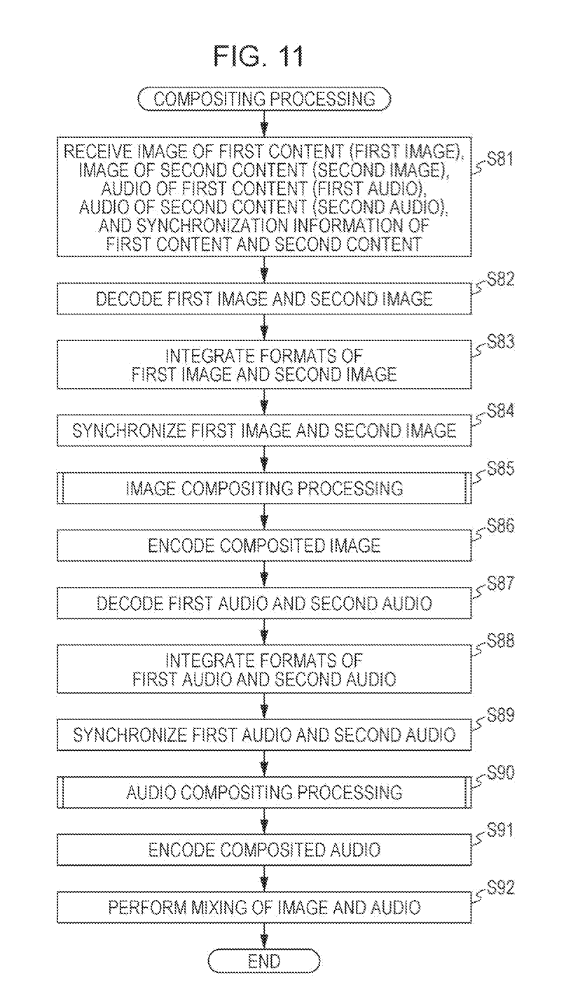

FIG. 11 is a flowchart for describing composited processing where the compositing unit 20 in FIG. 10 performs in step S32 of FIG. 3.

In step S81, the image decoding unit 51 receives the first image of the first content from the content selecting unit 19 and the second image of the second content, and the audio decoding unit 61 receives the first audio of the first content and the second audio of the second content from the content selecting unit 19.

Furthermore, in step S81, the synchronization processing units 53 and 63 receives synchronization information (synchronization information for compositing) to synchronize the first content and second content from the content selecting unit 19, and the processing advances to step S82.

In step S82, the image decoding unit 51 decodes the first image and second image, and, supplies to the image format converting unit 52, and the processing advances to step S83.

In step S83, the image format converting unit 52 performs format conversion to integrate the formats of the first image and second image from the image decoding unit 51, supplies this to the synchronization processing unit 53, and the processing advances to step S84.

In step S84, the synchronization processing unit 53 synchronizes the first image and second image from the image format converting unit 52 according to the synchronization information for compositing and supplies the synchronized first image and second image which are obtained as a result, to the image compositing unit 54, and the processing advances to step S85.

In step S85, the image compositing unit 54 performs image compositing processing to composite the first image and second image from the synchronization processing unit 53, and supplies the composited image which is obtained as a result, to the image encoding unit 55, and the processing advances to step S86.

In step S86, the image encoding unit 55 encodes the composited image from the image compositing unit 54 and supplies to the maxing processing unit 66, and the processing advances to step S87.

In step S87, the audio decoding unit 61 decodes the first audio and second audio and supplies to the audio format converting unit 62, and the processing advances to step S88.

In step S88, the audio format converting unit 62 performs format conversion to integrate to a format the first audio and second audio from the audio decoding unit 61, and supplies to the synchronization processing unit 63, and the processing advances to step S89.

In step S89, the synchronization processing unit 63 synchronizes the first audio and second audio from the audio format converting unit 62 according to the synchronization information for compositing and supplies the synchronized first audio and second audio obtained as a result to the audio compositing unit 64, and the processing advances to step S90.

In step S90, the audio compositing unit 64 performs audio composited processing to composite the first audio and second audio from the synchronization processing unit 63, and supplies the composited audio which is obtained as a result to the audio encoding unit 65, and the processing advances to step S91.

In step S91, the audio encoding unit 65 encodes composite audio from the audio compositing unit 64, and supplies to the maxing processing unit 66, and the processing advances to step S92.

In step S92, the maxing processing unit 66 performs maxing (integration) of the composited image from the image encoding unit 66 and the composited audio from the audio encoding unit 65 into one bit stream as composited content, and outputs this, and the composited processing ends.

As described above, the content processing system of FIG. 1 obtains audio feature amount of audio included in content including audio, generates synchronization information to synchronize multiple contents including the same or similar audio signal components based on the audio feature amount, and generates the composited content with the multiple contents synchronized and composited, thereby synchronizing between multiple contents when compositing the multiple contents.

Therefore, the user can easily enjoy synchronizing playing such as mashup of the music performance contents handling the same tune, as the contents do not have to be temporally synchronized manually.

Also, the content processing system of FIG. 1 can generate composited content of which the multiple content including the content of interest are synchronized and composited as content of interest, even if the content has been subjected to editing and compression, such as scene cuts or trimming.

Furthermore, with the content processing system of FIG. 1, synchronization information does not have to be added manually so that a large quantity of varied content can be handled, and cooperating with online moving image and audio sharing services and the like, services that provide composited content to many users can be realized.

The content processing system of FIG. 1 is particularly useful in the case where multiple content, which has common signal components (the same or similar audio signal component), e.g., users singing with, dancing with, playing instruments with the same tune are recorded are composited in one content (composited content).

### First Configuration Example of Audio Compositing Unit 64

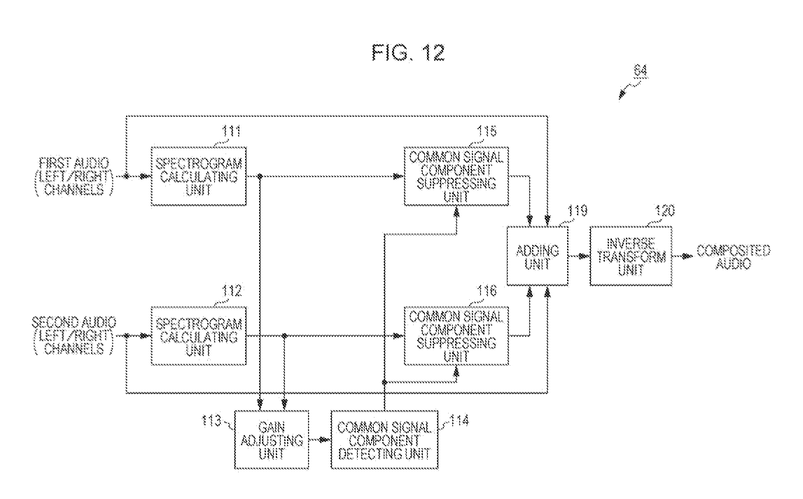

FIG. 12 is a block diagram illustrating a first configuration example of an audio compositing unit 64 of FIG. 10. In FIG. 12, the audio compositing unit 64 has spectrogram calculating units 111 and 112, a gain adjusting unit 113, a common signal component detecting unit 114, common signal component suppression units 115 and 116, an adding unit 119, and an inverse transform unit 120; and, for example, common signal components (of the same or similar audio signal components) included in the first audio and second audio are suppressed and composited for first audio and second audio per channel, such as a left channel and a right channel.

The first audio which has been synchronized with the second audio from the synchronization processing unit 63 is supplied to the spectrogram calculating unit 111. The spectrogram calculating unit 111 calculates a spectrogram of the first audio supplied therein, and supplies to the gain adjusting unit 113 and common signal component suppression unit 115.

The second audio which has been synchronized with the first audio from the synchronization processing unit 63 is supplied to the spectrogram calculating unit 112. The spectrogram calculating unit 112 calculates a spectrogram of the second audio supplied therein, and supplies to the gain adjusting unit 113 and common signal component suppression unit 116.

The gain adjusting unit 113 detects a peak (spectral peak), which is the maximum value from a spectrogram of the first audio from the spectrogram calculating unit 111, and also detects the spectral peak from a spectrogram of the second audio from the spectrogram calculating unit 112. Furthermore, the gain adjusting unit 113 detects (a set of) the first and second spectral peak at a position (frequency) near each other from the first spectral peak, which is the spectral peak of the first audio, and the second spectral peak, which is the spectral peak of the second audio. Here, the first and second spectral peaks at a positions near each other are called adjacent peaks.

The gain adjusting unit 113 performs gain adjusting, so as to match the size (power) of the first and second spectral peak, which are an adjacent peaks, as much as possible, to the gain to adjust gain (power) (volume) of first audio, where a spectrogram is supplied from the spectrogram calculating unit 111, and second audio, where a spectrogram is supplied from the spectrogram calculating unit 112, and supplies a post-gain adjustment spectrogram of first audio and second audio to the common signal component detecting unit 114.

The common signal component detecting unit 114 detects frequency components, where the difference of spectrum amplitude (power) is less than the threshold, as the common signal components of the first and second audio, for more than the predetermined time in a spectrogram of the first audio and second audio after the gain adjusting from the gain adjusting unit 113, and supplies to the common signal component suppression units 115 and 116.

The common signal component suppression unit 115 suppresses common signal components included in the spectrogram of the first audio from the spectrogram calculating unit 111, based on the common signal component from the common signal component detecting unit 114 (including frequency components of the frequency of the common signal component from the common signal component detecting unit 114, of the spectrograms of the first audio, to be zero), and supplies a spectrogram of the first audio (hereinafter referred to as first suppressed audio) in which the common signal component has been suppressed, to the adding unit 119.

The common signal component suppression unit 116 suppresses common signal components included in the spectrogram of the second audio from the spectrogram calculating unit 112, based on the common signal components from the common signal component detecting unit 114 (including frequency components of the frequency of common signal component from the common signal component detecting unit 114 of spectrograms of the second audio, to be zero), and supplies the spectrogram of the second audio, (hereinafter, referred to as second suppressed audio) suppressed the common signal components, to the adding unit 119.

A spectrogram of the first suppressed audio from the common signal component suppression unit 115 and a spectrogram of the second suppressed audio from the common signal component suppression unit 116 are supplied, and otherwise, the same first audio as with that to the spectrogram calculating unit 111 (hereinafter, referred to as original first audio), and the same second audio as with that to the spectrogram calculating unit 112 (hereinafter, referred to as original second audio) is supplied to the adding unit 119.

The adding unit 119 obtains phase properties of the original first audio, and calculates a complex spectrum of the first suppressed audio using the phase properties and a spectrogram of the first suppressed audio from the common signal component suppression unit 115. Furthermore, the adding unit 119 calculates a complex spectrum of the second suppressed audio similarly, adds the complex spectrum of the first suppressed audio to the complex spectrum of the second suppressed audio, and supplies to the inverse transform unit 120.

The inverse transform unit 120 performs inverse transformation to signals of a time region by performing inverse short term Fourier transformation on signals of frequency region which is an addition value of the complex spectrum of the first suppressed audio and complex spectrum of the second suppressed audio from the adding unit 119, and outputs as composited audio.

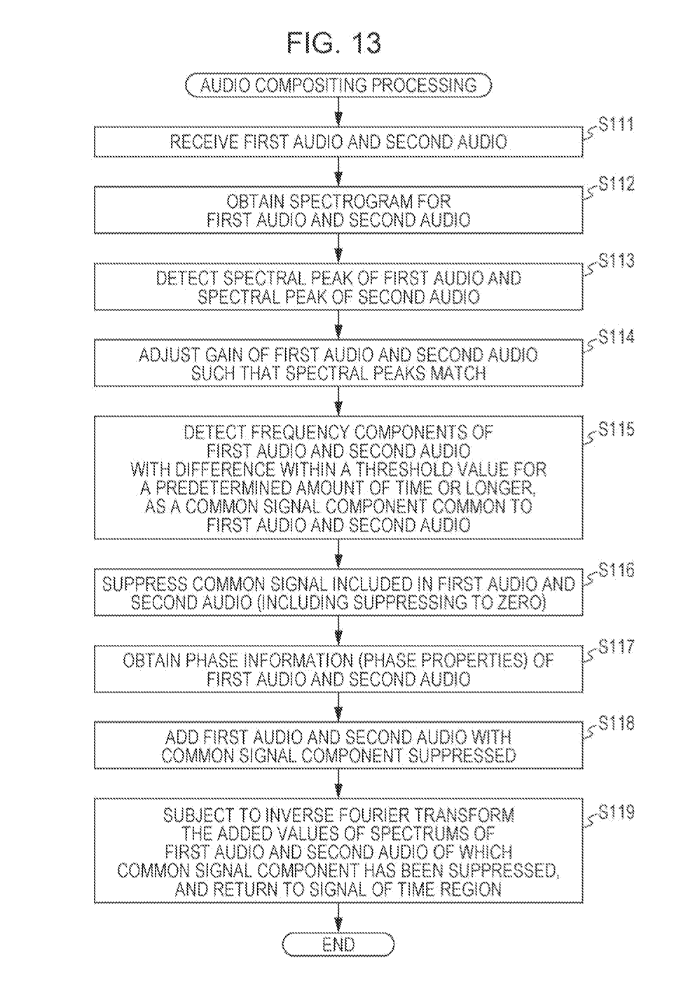

FIG. 13 is a flowchart for describing audio compositing processing where the audio compositing unit 64 in FIG. 12 performs at step S90 in FIG. 11.

In step S111, the spectrogram calculating unit 111 and adding unit 119 receive the first audio from the synchronization processing unit 63 (FIG. 10), and the spectrogram calculating unit 112 and adding unit 119 receive the second audio from the synchronization processing unit 63, and the processing advances to step S112.

In step S112, the spectrogram calculating unit 111 calculates a spectrogram of the first audio, and supplies to the gain adjusting unit 113 and common signal components suppression unit 115, and the spectrogram calculating unit 112 also calculates spectrogram of the second audio, and supplies to the gain adjusting unit 113 and common signal component suppression unit 116, and the processing advances to step S113.

In step S113, the gain adjusting unit 113 detects the spectral peak (first spectral peak) from the spectrogram of the first audio from the spectrogram calculating unit 111, and the spectral peak (second spectral peak) from the spectrogram of the second audio from the spectrogram calculating unit 112, and the processing advances to step S114.

In step S114, the gain adjusting unit 113 detects the first and second spectral peak as the adjacent peaks, i.e., the first and second spectral peak at a position near each other, from the first spectral peak which is spectral peak of the first audio and the second spectral peak which is spectral peak of the second audio.

Furthermore, the gain adjusting unit 113 performs gain adjusting which adjusts a gain of the first audio, where spectrogram is supplied from spectrogram calculating unit 111, and of the second audio, where spectrogram is supplied from the spectrogram calculating unit 112 so as to match with the size of the first and second spectral peak which are adjacent peaks, as much as possible, and supplies the spectrogram of the first and second audio after the gain adjusting to the common signal components detecting unit 114, and the processing advances from step S114 to step S115.

In step S115, the common signal component detecting unit 114 detects frequency components, which is the difference of the spectrum amplitude at the threshold or less for more than predetermined time in the spectrogram of the first audio and second audio after gain adjusting from the gain adjusting unit 113, as common signal components of the first audio and second audio, and supplies to the common signal component suppression unit 115 and 116, and the processing advances to step S116.

In step S116, the common signal component suppression unit 115 suppresses common signal components included in a spectrogram of the first audio from the spectrogram calculating unit 111, based on the common signal components from the common signal component detecting unit 114, and supplies the spectrogram of first suppressed audio, which is the first audio with the suppressed common signal components, to the adding unit 119.

Furthermore, based on common signal components from common signal component detecting unit 114, common signal components included in spectrogram of second audio from spectrogram calculating unit 112 are suppressed, and, in step S116, common signal components suppression unit 116 supplies spectrogram of second suppressed audio, which is second audio with suppressed common signal components, to adding unit 119, and the processing advances to step S117.

In step S117, the adding unit 119 obtains (acquires) phase properties of the original first audio and also obtains phase properties of the original second audio, and the processing advances to step S118.

In step S118, the adding unit 119 calculates complex spectrum of the first suppressed audio using phase properties of the original first audio and spectrogram of the first suppressed audio from the common signal component suppression unit 115. Furthermore, the adding unit 119 calculates complex spectrum of the second suppressed audio using phase properties of the original second audio and spectrogram of the second suppressed audio from the common signal component suppression unit 116. The adding unit 119 then adds the complex spectrum of the first suppressed audio and the complex spectrum of the second suppressed audio, and supplies an added value obtained as a result to the inverse transform unit 120, and the processing advances from step S118 to step S119.

In step S119, the inverse transform unit 120 performs inverse transformation to signals in a time region by performing inverse short term Fourier transformation for signals of the frequency region, which is an added value of the complex spectrum of the first suppressed audio and the complex spectrum of the second suppressed audio from the adding unit 119, and outputs as composited audio, and the audio compositing processing ends.

According to the audio compositing processing as described above, for example in the event that we assume content #1 in which the user singing is superimposed and recorded on a sound source of an original band performance, content #2 in which a user piano performance is superimposed and recorded on a sound source of an original band performance, and content #3 in which a user violin performance is superimposed and recorded on a sound source of an original band performance as content to be composited, the sound source of an original band performance as common signal components is suppressed and composited by sounds of contents #1 to #3 and as a result, acoustic arrangements of a user singing, piano performance, and a violin performance can be obtained as composited audio.

Note that, in the audio compositing unit 64, composited audio which is composited with the first suppressed audio and second suppressed audio, which have suppressed common signal components from the first audio and second audio, and otherwise composited audio which has composited the first audio and second audio that has not suppressed the common signal components, can be obtained.

In the audio compositing unit 64, whether composited audio which is composited with the first suppressed audio and second suppressed audio is obtained, or whether composited audio which does not suppress the first suppressed audio and second suppressed audio is obtained, is selected according to the operation of the user interface 11 (FIG. 1) by a user, for example.

Also, at the audio compositing unit 64 in FIG. 12, inverse transformation has been performed after the addition, that is to say, after adding the complex spectrum of the first suppressed audio and the complex spectrum of the second suppressed audio at inverse transform unit 119 of which are signals in a frequency range, the adding result obtained thereof is inversely transformed to signals in a temporal range via short term Fourier transformation at inverse transform unit 120; however by performing the addition after the inverse transformation at inverse transform unit 120, that is to say, by each complex spectrum of the first suppressed audio and the second suppressed audio of which are signals in a frequency range, being inversely transformed to signals in a temporal range via inverse short term Fourier transformation, the addition is enabled of the first suppressed audio and the second suppressed audio of which are signals in a temporal range obtained as the result.

Note however, that while in the event of performing inverse transformation after adding, the object of short term Fourier transformation, which is inverse transform, is only an added value of the complex spectrum of the first suppressed audio and the complex spectrum of the second suppressed audio, in the event of performing adding after inverse transforming, the object of short term Fourier transformation, which is inverse transformation, is two with the complex spectrum of the first suppressed audio and the complex spectrum of the second suppressed audio, and accordingly from the viewpoint of calculating amount, performing inverse transformation after adding is much more useful than performing adding after the inverse transformation.

### Configuration Example of Image Compositing Unit 54

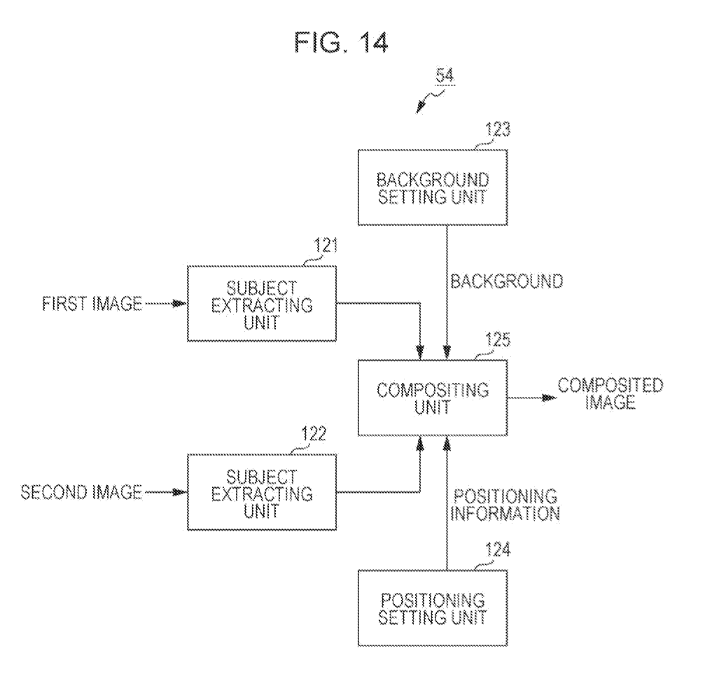

FIG. 14 is a block diagram illustrating a configuration example of image compositing unit 54 in FIG. 10. In FIG. 14, image compositing unit 54 has subject extracting units 121 and 122, a background setting unit 123, a positioning setting unit 124, and a compositing unit 125, and, for example, a subject is extracted from the first image and second image each, and generates predetermined composited image superimposed in the background.

The first image synchronized with the second image from the synchronization processing unit 53 is supplied to the subject extracting unit 121. The subject extracting unit 121 extracts a subject (foreground) from the first image supplied therein and supplies to the compositing unit 125.

The second image synchronized with the first image from the synchronization processing unit 53 is supplied to the subject extracting unit 122. The subject extracting unit 122 extracts a subject from second image supplied therein and supplies to compositing unit 125.

The background setting unit 123 sets, for example, an image to be used as a background for the composited image, according to the operation of the user interface 11 (FIG. 1) by a user, and supplies to the compositing unit 125. That is to say, the background setting unit 123 stores the multiple images as the background candidates, which are candidates of an image to serve as a background of the composited image, and supplies the list of the multiple background candidates to the user interface 11 so as to be displayed.

In the event that the user interface 11 is operated so that a user who has seen a list of the multiple background candidates selects background candidates to use in the background of the composited image, the background setting unit 123 sets (selects) a background of the composited image and supplies to the compositing unit 125, according to operations of the user interface 11.

The positioning setting unit 124 supplies, to the compositing unit 125, positioning information representing the positioning, which is a positioning configured for the first image and second image when composited into a composited image from the first image and second image thereof, according to user input of user interface 11.

For example, positioning information includes a direction of arrangement (e.g., a row or column or the like) of the first image and second image in the composited image, and order of arrangement (e.g., the positioning order of what number the first image and second image are positioned from the left in the case of a row) of the first image and second image in the composited image.

For example, the direction of arrangement of the first image and second image, and the order of arrangement of the first image and second image both can be set according to the operation of the user interface 11. Also, for example, the direction of arrangement of the first image and second image is set according to the operation of the user interface 11, and the order of arrangement of the first image and second image can be randomly set by the positioning setting unit 124.

The compositing unit 125 generates and outputs a composited image, obtained by synchronizing the first image, second image, and a background, by superimposing a subject (hereinafter, referred to as the first subject) included in the first image from the subject extracting unit 121, and a subject (hereinafter, referred to as the second subject) included in the second image from the subject extracting unit 122 according to positioning information from the positioning setting unit 124 on the background from the background setting unit 123.

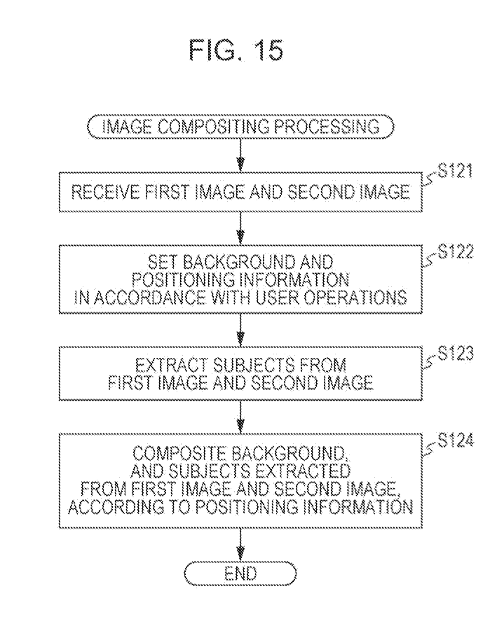

FIG. 15 is a flowchart for describing the image compositing processing where the image compositing unit 54 in FIG. 14 performs in step S85 of FIG. 11.

In step S121, the subject extracting unit 121 receives the first image from the synchronization processing unit 53 (FIG. 10), and the subject extracting unit 122 also receives the second image from the synchronization processing unit 53, and the processing advances to step S122.

In step S122, the background setting unit 123 sets a background of a composited image according to the operation of the user interface 11 by a user, and supplies to the compositing unit 125, while the positioning setting unit 124 sets positioning of the first image and second image on the composited image according to the operation of the user interface 11 by the user, and supplies positioning information to represent the positioning to the compositing unit 125, and the processing advances to step S123.

In step S123, the subject extracting unit 121 extracts a subject (the first subject) from the first image and supplies to the compositing unit 125, and the subject extracting unit 122 extracts a subject (the second subject) from the second image and supplies to compositing unit 125, and the processing advances to step S124.

In step S124, the compositing unit 125 generates and outputs the composited image in which are composited the first subject, second subject, and a background by superimposing the first subject from the subject extracting unit 121 and the second subject from the subject extracting unit 122, with positioning according to the positioning information from the positioning setting unit 124 by the background from the background setting unit 123, and the composited image compositing processing ends.

According to the image compositing processing as described above, for example, in the event that content 1 of a shooting of a user A dancing to an original band performance, and a content 2 of a shooting of a user B playing an instrument to an original band performance, are taken as content to be composited wherein the images of user A and user B are extracted as the subjects, and when composited, produces a result in which the composited image is such that the user A and user B seem to be performing together. Here, with the composited image, it is desirable to place the first and second subjects sufficiently apart so that the moving first and second subjects do not overlap in the event that the first and second subjects move.

Note that, with the image compositing unit 54, a composited image where the first image and second image themselves are positioned can be generated as the composited image, besides a composited image which has positioned therein the first subject and second subject extracted from each of the first image and second image.

In the image compositing unit 54, whether to generate a composited image in which are positioned the first subject and second subject extracted from each of the first image and second image, or whether to generate a composited image in which are positioned the first image and second image, can be selected according to the operation of the user interface 11 (FIG. 1) by a user, for example.

### Second Configuration Example of Audio Compositing Unit 64

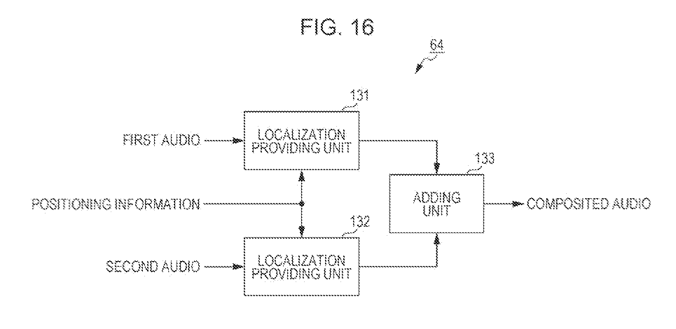

FIG. 16 is a block diagram illustrating a second configuration example of the audio compositing unit 64 in FIG. 10. For example, in FIG. 16, the audio compositing unit 64 has localization providing units 131 and 132, and an adding unit 133, and composites the first audio and second audio for each channel such as the left channel and the right channel.

The first audio synchronized with the second audio is supplied from the synchronization processing unit 63 to the localization providing unit 131. Furthermore, positioning information representing positioning of the first image and second image on the composited image set at the positioning setting unit 124 (FIG. 14) is supplied to the localization providing unit 131.

The localization providing unit 131 provides localization to the first audio supplied thereto, such that the first audio can be heard from the direction of the position where the first image imaging the subject who is making the first audio is positioned, in accordance with the positioning information set in the positioning setting unit 124, and supplies to the adding unit 133.

Specifically, the localization providing unit 131 recognizes a positioning location on the composited image of a subject (e.g., the player who plays a musical instrument) producing the first audio, from the positioning information, and obtains the positional relationship between the subject producing the first audio and a virtual recording position of the composited image of the composited contents based on the positioning location. Further, the localization providing unit 131 convolutes spatial transfer response, in accordance with the positional relation between the subject producing the first audio and the virtual recording position, in the first audio, thereby providing the first audio with localization such that the first audio can be heard from the direction of the position of the subject producing the first audio.

The second audio which has been synchronized with the first audio, from the synchronization processing unit 63, is supplied to the localization providing unit 132. Furthermore, positioning information representing the positioning of the first image and second image on the composited image, set by the positioning setting unit 124 (FIG. 14), is supplied to the localization providing unit 132.

In the same way as with the localization providing unit 131, the localization providing unit 132 adds localization such that the second audio can be heard from the direction of the position where the second image including the subject who is producing the second audio is positioned, as to the second audio supplied thereto, in accordance with the positioning information set at the positioning setting unit 124, and supplies to the adding unit 133.

The adding unit 133 adds the first audio from the localization providing unit 131 and the second audio from the localization providing unit 132, and outputs an added value as composite audio.

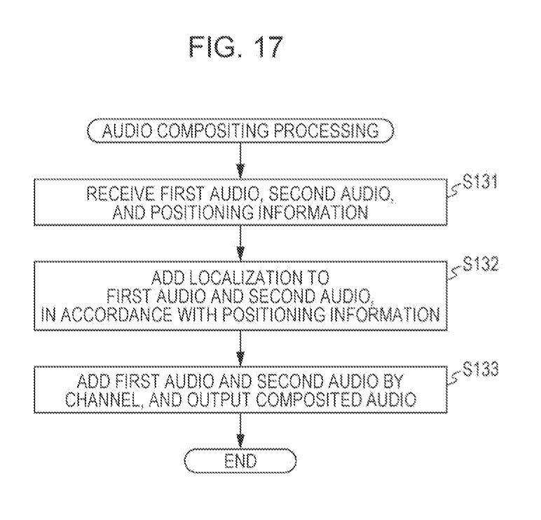

FIG. 17 is a flowchart illustrating audio compositing processing which the audio compositing unit 64 of FIG. 16 performs in step S90 of FIG. 11.

In step S131, the localization providing unit 131 receives the first audio set in the first audio from the synchronization processing unit 63 (FIG. 10) and positioning information set at the positioning setting unit 124 (FIG. 14), and also the localization providing unit 132 receives the second audio from the synchronization processing unit 63 and positioning information set at the positioning setting unit 124, and the processing advances to step S132.

In step S132, the localization providing unit 131 adds localization as to the first audio and supplies to the adding unit 133, in accordance with the positioning information, and the localization providing unit 132 adds localization as to the second audio, and supplies to the adding unit 133 in accordance with the positioning information, and the processing advances to step S133.

In step S133, the adding unit 133 adds the first audio from the localization providing unit 131 and the second audio from the localization providing unit 132 and, outputs the added value as the composite audio, and the audio compositing processing ends.

According to the audio compositing processing, for example, in the event that we take a content #1 where a vocal singing with an original band performance, a content #2 where a guitar player playing the guitar with an original band performance, and content #3 where a bass player playing a bass with an original band performance, have been shot as contents to be composited, at the image compositing unit 54 of FIG. 14, in a case where the composited image is generated such that the vocal is positioned at the center, the guitar player is positioned on the right, and the base player is positioned on the left, composite audio with a sense of presence can be generated in which the localization of sound has been realized such that the vocal can be heard from the front, the guitar performance can be heard from the right side, and the bass performance can be heard from the left side, respectively.

### Third Configuration Example of Audio Compositing Unit 64

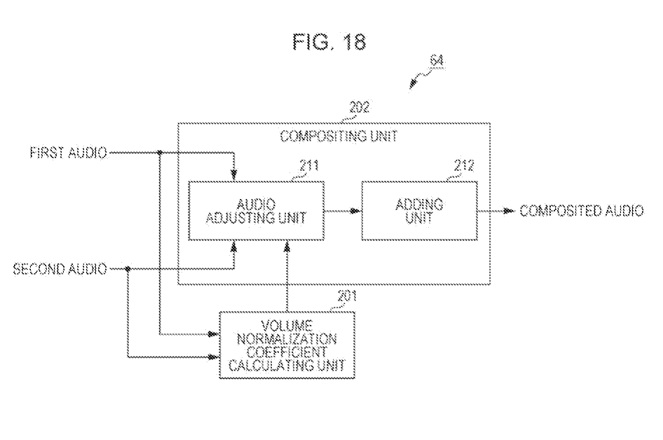

FIG. 18 is a block diagram illustrating a third configuration example of the audio compositing unit 64 in FIG. 10.

In FIG. 18, the audio compositing unit 64 has a volume normalization coefficient calculating unit 201, and a compositing unit 202, and for example, composites the first audio and second audio by adjusting volume of each channel such as the left channel and the right channel.

The first audio and second audio from the synchronization processing unit 63 (FIG. 10) are supplied to the volume normalization coefficient calculating unit 201. The volume normalization coefficient calculating unit 201 calculates a volume normalization coefficient to change volume of the first audio and second audio based on the first audio and second audio from the synchronization processing unit 63, and supplies to the compositing unit 202.

Here, for example, at the volume normalization coefficient calculating unit 201, the volume normalization coefficient to change the volume of the first audio and second audio can be calculated so that the level of common signal components included in the first audio and second audio match.

The compositing unit 202 has an audio adjusting unit 211, and an adding unit 212, and performs compositing with the optimal volume ratio of the first audio and second audio being obtained using a volume normalization coefficient from the volume normalization coefficient calculating unit 201, and the volume of the first audio and second audio being adjusted in accordance with the volume ratio.

The first audio and second audio from the synchronization processing unit 63 (FIG. 10) are supplied to the audio adjusting unit 211, and the volume normalization coefficient from the volume normalization coefficient calculating unit 201 is also supplied.

The audio adjusting unit 211 obtains the optimal volume ratio between the first audio and second audio (the volume ratio with the first audio and second audio where a user will feel that mixing has been performed suitably in the composite audio in which the first and second audio have been composited) using the volume normalization coefficient from the volume normalization coefficient calculating unit 201.

Furthermore, the audio adjusting unit 211 adjusts the volume of the first audio and second audio from the synchronization processing unit 63 so as to be the optimal volume ratio, and supplies to the adding unit 212.

The adding unit 212 adds the first audio and second audio which the volume from the audio adjusting unit 211 has adjusted, and outputs the added value as composite audio.

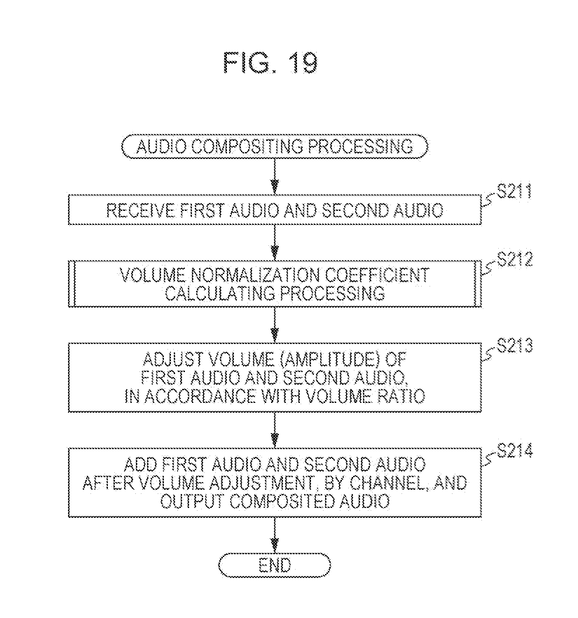

FIG. 19 is a flowchart for describing audio compositing processing which an audio compositing unit 64 in FIG. 18 performs in step S90 of FIG. 11.

In step S211, the volume normalization coefficient calculating unit 201 and audio adjusting unit 211 receive the first audio and second audio from the synchronization processing unit 63 (FIG. 10), and the processing advances to step S212.

In step S212, the volume normalization coefficient calculating unit 201 performs volume normalization coefficient calculation processing to calculate the volume normalization coefficient to change volume of the first audio and second audio so that the level of the common signal components included in the first audio and second audio match, and supplies the volume normalization coefficient obtained as a result to the compositing unit 202, and the processing advances to step S213.

In step S213, the audio adjusting unit 211 of the compositing unit 202 obtains the optimal volume ratio of the first audio and second audio from the synchronization processing unit 63 using the volume normalization coefficient from the volume normalization coefficient calculating unit 201. The audio adjusting unit 211 then adjusts the volume (the amplitude) of the first audio and second audio from the synchronization processing unit 63 so as to be the optimal volume ratio, and supplies to the adding unit 212, and the processing advances to step S214.

In step S214, the adding unit 212 adds the first audio and second audio of the optimal volume ratio from the audio adjusting unit 211 and outputs the added value as composite audio, and the audio compositing processing ends.

### Configuration Example of Volume Normalization Coefficient Calculating Unit 201

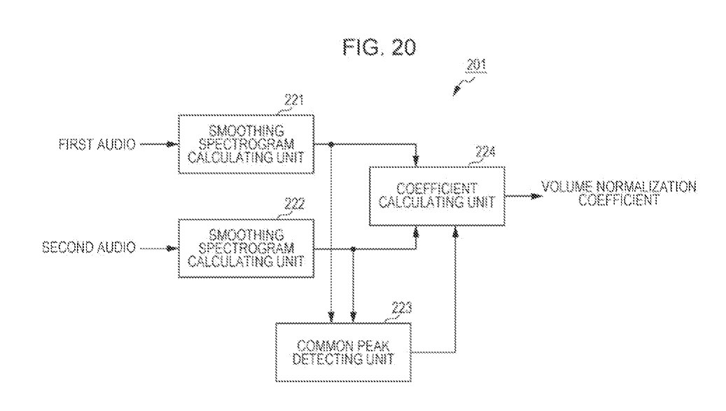

FIG. 20 is a block diagram illustrating a configuration example of the volume normalization coefficient calculating unit 201 in FIG. 18. In FIG. 20, the volume normalization coefficient calculating unit 201 has smoothed spectrogram calculating units 221 and 222, a common peak detecting unit 223, and a coefficient calculating unit 224, and calculates volume normalization coefficients to change the volume of the first audio and the second audio such that the levels of common signal components included in the first audio and second audio match.

The first audio which has been synchronized with the second audio, supplied from the synchronization processing unit 63 (FIG. 10) is supplied to the smoothed spectrogram calculating unit 221.

The smoothed spectrogram calculating unit 221 calculates the spectrogram of the first audio supplied thereto. Further, the smoothed spectrogram calculating unit 221 smoothes the spectrogram of the first audio in the frequency direction, thereby, in a case where the harmonic frequency component is at peak level (maximal value), a spectrogram having a degree of precision whereby the peak can be detected (hereinafter also referred to as smoothed spectrogram) is obtained as feature information of the first content including the first audio, which is then supplied to the common peak detecting unit 223 and the coefficient calculating unit 224.

The smoothed spectrogram calculating unit 222 is supplied with the second audio which has been synchronized with the first audio, from the synchronization processing unit 63.

In the same way as with the smoothed spectrogram calculating unit 221, the smoothed spectrogram calculating unit 222 obtains a smoothed spectrogram of the second audio supplied thereto, and supplies this to the common peak detecting unit 223 and coefficient calculating unit 224.

The common peak detecting unit 223 detects a first spectrum peak which is the peak of the smoothed spectrogram of the first audio from the smoothed spectrogram calculating unit 221, and also detects a second spectrum peak which is the peak of the smoothed spectrogram of the second audio from the smoothed spectrogram calculating unit 222.

Further, the common peak detecting unit 223 detects first and second spectrum peaks at mutually close positions (frequencies) from the first and second spectrum peaks, as common peaks which are peaks of common signal components, and supplies the frequency (position) and size (amplitude, i.e., power) of the common peaks to the coefficient calculating unit 224 as common peak information.

The coefficient calculating unit 224 recognizes the first and second spectrum peaks which are common peaks in the spectrogram of the first audio from the smoothed spectrogram calculating unit 221 and the spectrogram of the second audio from the smoothed spectrogram calculating unit 222, based on the common peak information from the common peak detecting unit 223. Further, the coefficient calculating unit 224 calculates and outputs a predetermined multiple which, in the event of having corrected the volume of the second audio by a predetermined multiple, minimizes the error between the corrected peak which is the second spectrum peak and is a common peak and the first spectrum peak which is a common peak along with the second spectrum peak, as a volume normalization coefficient for changing the volume of the second audio such that the levels of the common signal components included in the first audio and the second audio match.

Now, let us say here that the first audio is audio of a content #1 where the user has recorded his/her own arrangement of a guitar part played along with the sound of a CD of a commercially-purchased tune A, and the second audio is the sound of the CD of the same tune A or is audio of a content #2 where the user has recorded his/her voice singing along with a karaoke version of the tune A (singing).

In a case of compositing the first audio and the second audio, the volume of the guitar part of the first audio and the volume of the voice (vocal) of the second audio are preferably composited with a suitable (optimal) volume ratio.

In order to composite the volume of the guitar part of the first audio and the volume of the vocal of the second audio with a suitable volume ratio, at least one of the volume of the guitar part of the first audio and the volume of the vocal of the second audio has to be adjusted, and to this end, the volume of the guitar part included in the first audio alone, and the volume of the vocal included in the second audio alone, have to be accurately comprehended.

However, the first audio includes the sound of the CD of the tune A besides the guitar part, so it is difficult to accurately obtain the volume of the guitar part included in the first audio alone with the first audio in a such a state.

In the same way, the second audio includes the sound of the CD of the tune A or the karaoke version of the tune A besides the vocal, so it is difficult to accurately obtain the volume of the vocal included in the second audio alone with the second audio in a such a state.

Now, in this case, the first audio and second audio include the sound of the CD of the tune A or the karaoke version of the tune A, as common signal components. While the volume of the common signal component included in the first audio and the volume of the common signal component included in the second audio differ depending on the recording level at the time of recording each of the first audio and second audio, and so forth, it can be assumed that the first audio and second audio were recorded with the common signal components and other signal components suitably balanced.

That is to say, the guitar part included in the first audio can be expected to have been recorded with a volume suitable for the guitar part in relation as to the sound of the CD of the tune A, so as to accentuate the vocal included in the sound of the CD of the tune A included in that first audio.

In the same way, the vocal included in the second audio can be expected to have been recorded with a volume suitable for the vocal in relation as to the sound of the CD of the tune A included in that second audio or the sound of the karaoke version of the tune A (in the event that the sound of the CD of the tune A is included in the second audio, a volume generally equivalent to the vocal included in the sound of CD of that tune A).

In this case, a volume ratio between the first audio and second audio is decided (calculated) such that the volume of the sound of the CD of the tune A which is the common signal component included in the first audio, and the volume of the sound of the CD of the tune A or the sound of the karaoke version of the tune A which is the common signal component included in the second audio, match, and by compositing the first audio and the second audio following this volume ratio, the first audio and the second audio can be composited with the volume suitably adjusted.

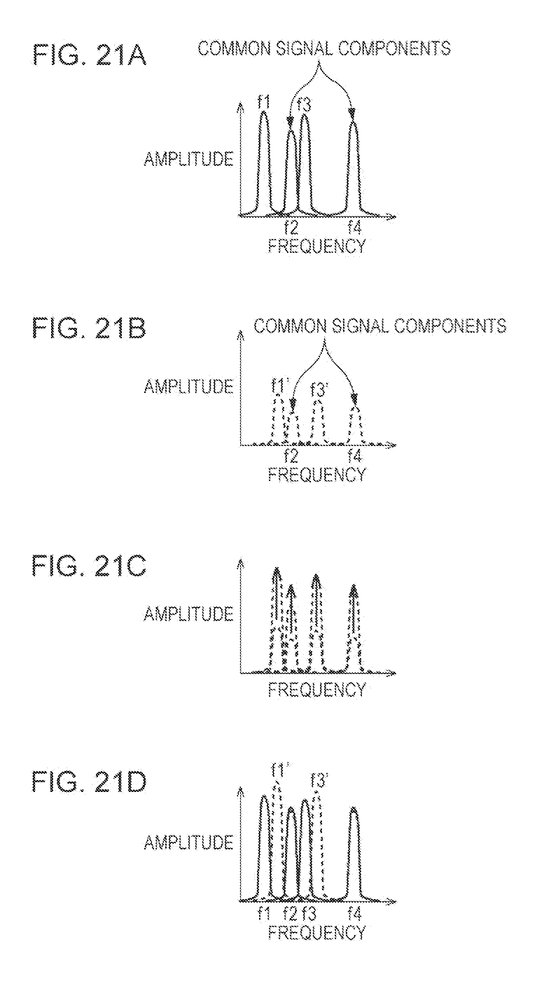

FIGS. 21A through 21D illustrate a method of matching the volume of the common signal component included in the first audio and volume of the common signal component included in the second audio.

FIG. 21A illustrates an example of a power spectrum of the first audio, and FIG. 21B illustrates an example of a power spectrum of the second audio.

With the power spectrum of the first audio in FIG. 21A, frequencies f1, f2, f3, and f4 are spectrum peaks (first spectrum peaks), and with the power spectrum of the second audio in FIG. 21B, frequencies f1′, f2, f′3, and f4 are spectrum peaks (second spectrum peaks).

Now, of the frequencies f1, f2, f3, and f4 of the first spectrum peaks and the frequencies f1′, f2, f′3, and f4 of the second spectrum peaks, if we say that the frequencies f2 and f4 are spectrum peaks of common signal components (or spectrum peaks of which common signal components are dominant), adjusting at least one of the first audio and second audio, in this case the volume of the second audio, for example, allows the magnitude of the spectrum peaks of the common signal components in the first spectrum peaks and the spectrum peaks of the common signal components in the second spectrum peaks to be generally matched.

FIG. 21C is a diagram illustrating the power spectrum of the second audio after adjusting the volume. FIG. 21D is a diagram with the power spectrum of the first audio in FIG. 21A (solid line) and the power spectrum of the second audio in FIG. 21C after volume adjustment (dotted line), superimposed.

As shown in FIG. 21D, by adjusting the volume of the second audio, the magnitude of the first spectrum peak and second spectrum peak of frequency f2 which is a spectrum peak of a common signal component can be made to generally match, and the magnitude of the first spectrum peak and second spectrum peak of frequency f4 which is a spectrum peak of a common signal component can be made to generally match.

In the event that the first audio and second audio have been recorded with the common signal components and other signal components suitably balanced, adjusting the volume of the second audio such that the magnitude of the spectrum peaks of common signal components out of the first spectrum peaks and spectrum peaks of common signal components out of the second spectrum peaks generally match enables the first audio and second audio to be composited with a suitable volume ratio (a volume ratio where the volume of the guitar part included in the first audio and the volume of the vocal included in the second audio sound appropriate). Consequently, composited content sounding as if performers, who are playing independently in separate contents, are playing together, can be easily created from the multiple contents, for example.

The volume normalization coefficient calculating unit 201 in FIG. 20 calculates a volume normalization coefficient to change the volume of the second audio, such that the level of the common signal components included in the first audio and the second audio match. To this end, at the common peak detection unit 223, first and second spectrum peaks at a close position (frequency) to the first and second spectrum peaks are detected as common peaks which are peaks of the common signal components.

In FIG. 20, a set of the frequency component which is the first spectrum peak of frequency f2 in the power spectrum of the first audio in FIG. 20A and the second spectrum peak of frequency f2 in the power spectrum of the second audio in FIG. 20B is detected as common peaks.

Further, in FIG. 20, a set of the first spectrum peak of frequency f4 in the power spectrum of the first audio in FIG. 20A and the second spectrum peak of frequency f4 in the power spectrum of the second audio in FIG. 20B is detected as common peaks.

Thereafter, the coefficient calculating unit 224 (FIG. 20) calculates, as a volume normalization coefficient, a predetermined multiple which minimizes error between the corrected peak which is the second spectrum peak of the frequency f2 and is a common peak upon having corrected the volume of the second audio by the predetermined multiple, and the first spectrum peak of the frequency f2 which is a common peak along with the second spectrum peak, and error between the corrected peak which is the second spectrum peak of the frequency f4 and is a common peak, and the first spectrum peak of the frequency f4 which is a common peak along with the second spectrum peak.

Specifically, with the volume normalization coefficient calculating unit 201 in FIG. 20, a smoothed spectrogram is calculated for every predetermined temporal-length frame at the smoothed spectrogram calculating units 221 and 222.

At the common peak detecting unit 223, first spectrum peaks which are peaks in the smoothed spectrogram of the first audio are detected, and also second spectrum peaks which are peaks in the smoothed spectrogram of the second audio are detected, for each frame.

Further, at the common peak detecting unit 223, first and second spectrum peaks close to each other are detected from the first and second spectrum peaks, as common peaks which are peaks of common signal components, and the frequencies and magnitude of the common peaks are supplied to the coefficient calculating unit 224 as common peak information, for each frame.

At the coefficient calculating unit 224, the first and second spectrum peaks which are common peaks are recognized based on the common peak information from the common peak detecting unit 223, and a predetermined multiple, which minimizes the error between the corrected peak which is the second spectrum peak where the volume of the second audio has been corrected by a predetermined multiple, and the first spectrum peak which is a common peak along with the second spectrum peak, is calculated as an volume normalization coefficient for changing the volume of the first audio and second audio such that the levels of the common signal components included in the first audio and the second audio match.

That is to say, if we express the magnitude of a spectrum peak which is a k'th common peak in the spectrogram of a j'th frame of an i'th audio, as P(i, j, k), the coefficient calculating unit 224 calculates a value α which minimizes the summation D(α) of the error in Expression (1) as a volume normalization coefficient.

D(α)=Σ_{j,k}|P(1,j,k)−αP(2,j,k)| (1)

Now, in Expression (1), Σ_{j,k} represents a summation where variable j is taken as the integers of 1 through the whole sum of frames, and variable k is taken as the integers of 1 through the number of common peaks in the j'th frame. Note that here, we will say that the first audio and second audio signals are of the same time-length.

In the event that the number of content to be composited is three or more contents, at the coefficient calculating unit 224 one audio of the audio of the three or more contents is taken to serve as a reference audio (audio of which the volume normalization coefficient is 1), and the volume normalization coefficients of the audio of the other contents are obtained in the same way.

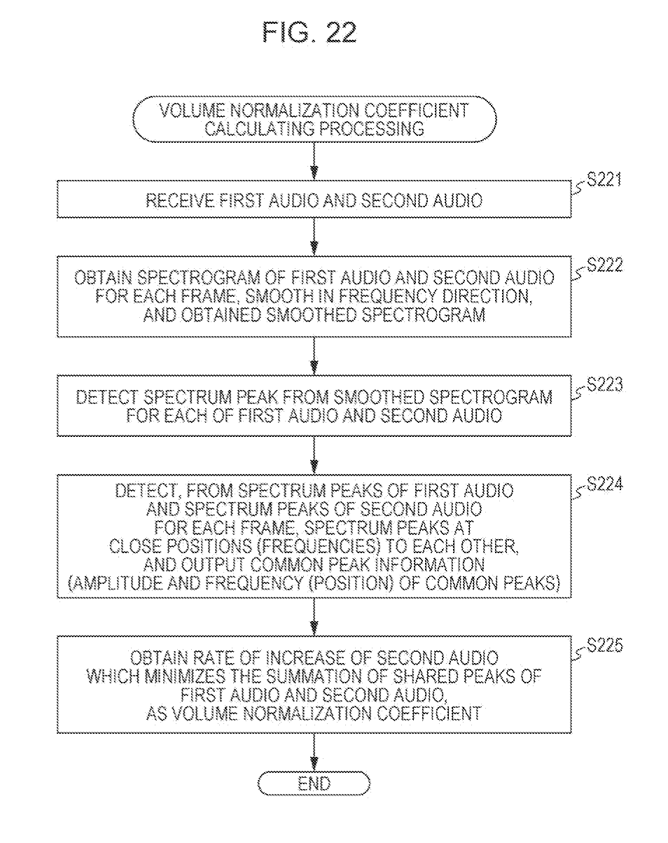

FIG. 22 is a flowchart for describing the volume normalization coefficient calculating processing which the volume normalization coefficient calculating unit 201 in FIG. 20 performs in step S212 in FIG. 19.

In step S221, the smoothed spectrogram calculating unit 221 receives the first audio from the synchronization processing unit 63 (FIG. 10), and the smoothed spectrogram calculating unit 222 receives the second audio from the synchronization processing unit 63, and the processing advances to step S222.

In step S222, the smoothed spectrogram calculating unit 221 calculates the spectrogram of the first audio, and smoothes the spectrogram of the first audio in the frequency direction, thereby obtaining a smoothed spectrogram of the first audio.

Further, in step S222, the smoothed spectrogram calculating unit 222 obtains a smoothed spectrogram of the second audio in the same way as with the smoothed spectrogram calculating unit 221.

The smoothed spectrogram calculating unit 221 then supplies the spectrogram of the first audio to the common peak detecting unit 223 and coefficient calculating unit 224, and also the smoothed spectrogram calculating unit 222 supplies the spectrogram of the second audio to the common peak detecting unit 223 and coefficient calculating unit 224, and the processing advances from step S222 to step S223.

In step S223, the common peak detecting unit 223 detects first spectrum peaks from the smoothed spectrogram of the first audio from the smoothed spectrogram calculating unit 221, and detects second spectrum peaks from the smoothed spectrogram of the second audio from the smoothed spectrogram calculating unit 222, and the processing advances to step S224.

In step S224, the common peak detecting unit 223 detects, from the first and second spectrum peaks, first and second spectrum peaks of close frequencies as common peaks, supplies the frequency and magnitude of the first and second spectrum peaks as the common peaks to the coefficient calculating unit 224 as common peak information, and the processing advances to step S225.

In step S225, the coefficient calculating unit 224 recognizes the first and second spectrum peaks which are common peaks, in the first spectrogram of the first audio from the smoothed spectrogram calculating unit 221 and the second spectrogram of the second audio from the smoothed spectrogram calculating unit 222, based on the common peak information from the common peak detecting unit 223.

Further, the coefficient calculating unit 224 calculates a predetermined multiple serving as a gain rate a which minimizes the error between a corrected peak which is the second spectrum peak when the volume of the second audio has been corrected by amplifying by a predetermined multiple which is the gain rate α, and the first spectrum peak which is a common peak along with the second spectrum peak, i.e., a value α which minimizes the summation D(α) of error in Expression (1), outputs this as a volume normalization coefficient, to change the volume of the second audio such that the levels of common signal components included in the first audio and second audio match, and the volume normalization coefficient calculating processing ends.

Note that with the audio adjusting unit 211 (FIG. 18), the volume normalization coefficient of the first audio is taken as 1 and the volume normalization coefficient from the volume normalization coefficient calculating unit 201 is used as the volume normalization coefficient of the second audio, for example, and the ratio in volume between the first audio and the second audio after adjustment where the volume of the first audio is adjusted to be onefold, which is the volume normalization coefficient of the first audio, and the second audio is adjusted by being multiplied by the volume normalization coefficient for the second audio, is obtained as the optimal volume ratio.

### Other Example of Volume Ratio Calculation

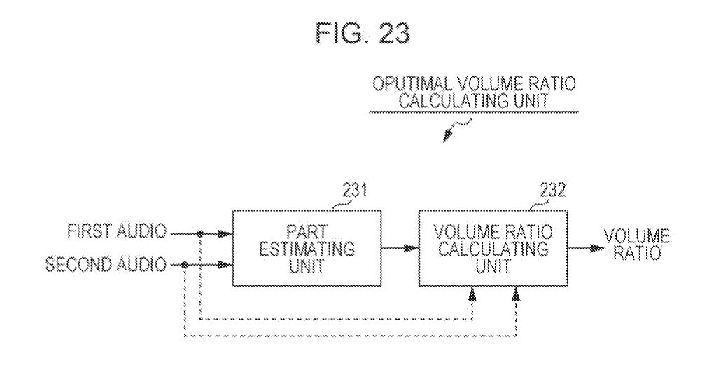

Note that the volume adjustment unit 211 in FIG. 18 can obtain volume ratio without using volume normalization coefficients. FIG. 23 is a block diagram illustrating a configuration example of a part of the volume adjustment unit 211 in FIG. 18 which obtains optimal volume ratio without using volume normalization coefficients (hereinafter also referred to as optimal volume ratio calculating unit).

In FIG. 23, the optimal volume ratio calculating unit has a part estimating unit 231 and a volume ratio calculating unit 232, and estimates the parts of each of the first audio and second audio, and decides volume ratio based on the parts of each of the first audio and second audio.

Now, while we have assumed with the volume normalization coefficient calculating unit 201 in FIG. 20 that the first audio and second audio are signals where the common signal components, and other signal components such as guitar parts or vocals or the like, have been recorded in an appropriately balanced manner (hereinafter, also referred to as balanced signals), but the first audio and second audio are not such balanced signals in every instance.

The optimal volume ratio calculating unit in FIG. 23 can decide an optimal volume ratio for compositing the first audio and second audio in cases where the first audio and second audio are balanced signals as a matter of course, and even in cases where the first audio and second audio are not balanced signals.

The part estimating unit 231 is supplied with the first audio and second audio from the synchronization processing unit 63 (FIG. 10).

The part estimating unit 231 estimates the parts of each of the first audio and second audio from the synchronization processing unit 63, and supplies to the volume ratio calculating unit 232.

The volume ratio calculating unit 232 calculates and outputs the volume ratio at the time of compositing of the first audio and second audio, based on the estimation results of the parts of each of the first audio and second audio from the part estimating unit 231.

### First Configuration Example of Part Estimating Unit 231

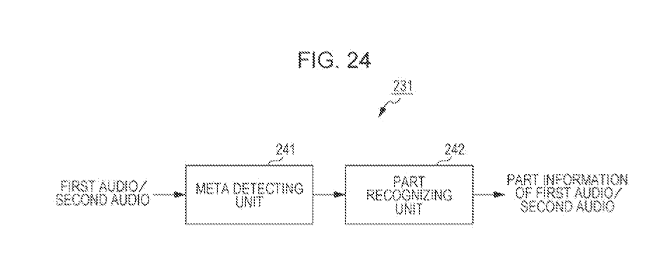

FIG. 24 is a block diagram illustrating a first configuration example of the part estimating unit 231 in FIG. 23. In FIG. 24, the part estimating unit 231 has a meta detecting unit 241 and a part recognizing unit 242. The meta detecting unit 241 is supplied with the first audio and second audio from the synchronization processing unit 63 (FIG. 10).

Now, with video sharing sites where music performance contents and the like are uploaded, there are cases where users uploading the contents and content viewers can attach meta data, such as content tiles, search keywords, and so forth, to the uploaded contents as tags or the like.

Now, we will say that part information of a part of a first audio (information indicating what sort of sound part other than the sound of the common signal components is included in the first audio, such as vocal, guitar, etc.) is attached to a first content including the first audio, as metadata. In the same way, we will say that part information of a part of a second audio is attached to a second content including the second audio, as metadata.

The meta detecting unit 241 detects the metadata of each of the first audio and second audio, and supplies to the part recognizing unit 242.

The part recognizing unit 242 recognizes (extracts) and outputs part information of each of the first audio and second audio from the metadata of each of the first audio and second audio from the meta detecting unit 241.

### First Configuration Example of Volume Ratio Calculating Unit 232

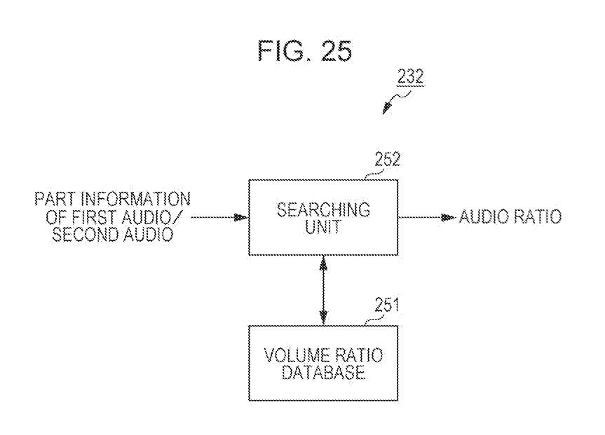

FIG. 25 is a block diagram illustrating a first configuration example of the volume ratio calculating unit 232 in FIG. 23. In FIG. 25, the volume ratio calculating unit 232 has a volume ratio database 251 and a searching unit 252.

Registered in the volume ratio database 251 are volume ratios regarding parts of typical instruments, vocals, and so forth, in concerted form of various instrument ensembles (e.g., volume ratios with a predetermined part such as a vocal or the like as a reference).

The searching unit 252 is supplied with part information of each of the first audio and second audio from the part estimating unit 231 (FIG. 23). The searching unit 252 searches and outputs the volume ratio database 251 for volume ratios regarding each part in the concerted form of the parts indicated by the part information of each of the first audio and second audio.

### Second Configuration Example of Part Estimating Unit 231

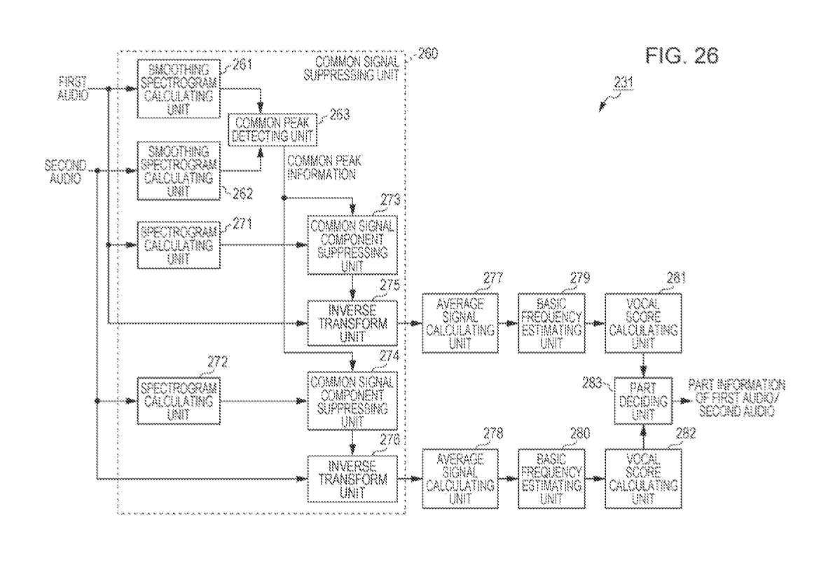

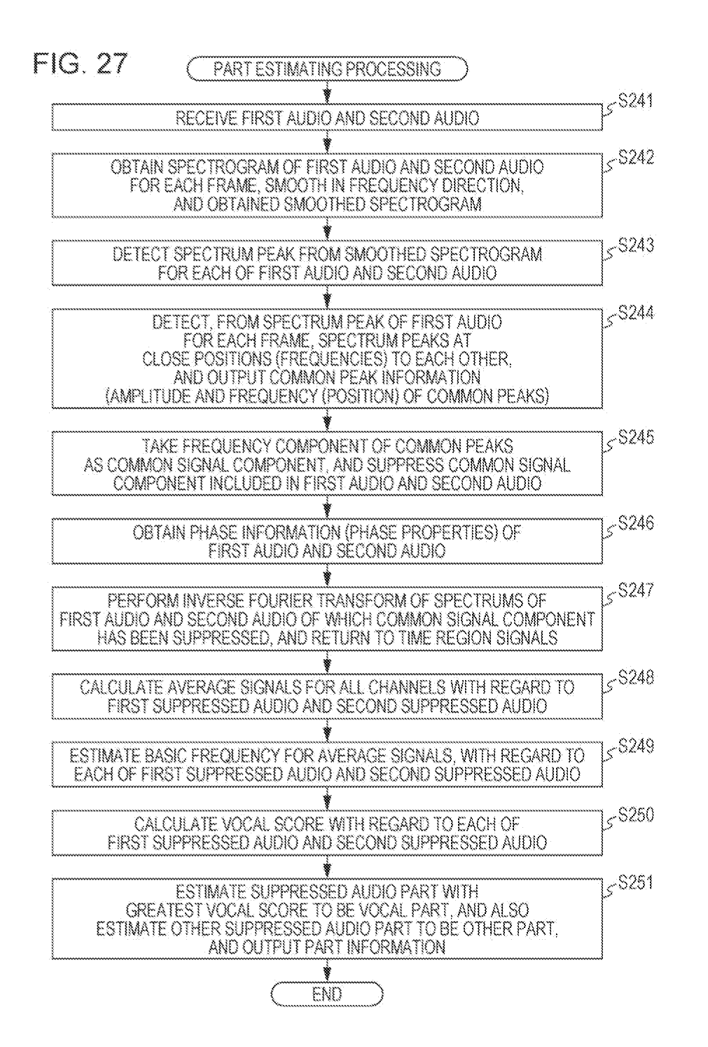

FIG. 26 is a block diagram illustrating a second configuration example of the part estimating unit 231 in FIG. 23. With the part estimating unit 231 in FIG. 24, we have assumed metadata of part information being attached to the first content including the first audio and the second content including the second audio, with each of the parts of the first audio and second audio being estimated using the metadata, but the part estimating unit 231 in FIG. 26 estimates the parts of each of the first audio and second audio without using metadata (without metadata).

In FIG. 26, the part estimating unit 231 has a common signal suppressing unit 260, average signal calculating units 277 and 278, basic frequency estimating units 279 and 280, vocal score calculating units 281 and 282, and a part deciding unit 283, and estimates whether each of the parts of the first audio and second audio is a vocal part, or other than a vocal part (guitar part or the like, hereinafter, also referred to as non-vocal part).

Now, in order to simplify description, hereinafter, we will say that each part of the first audio and the second audio is monophonic.

The common signal suppressing unit 260 includes smoothed spectrogram calculating units 261 and 262, a common peak detecting unit 263, spectrogram calculating units 271 and 272, common signal component suppressing units 273 and 274, and inverse transform units 275 and 276, and performs common signal suppressing processing where the common signal components from the first audio and second audio are suppressed.

The smoothed spectrogram calculating unit 261 is supplied with the first audio which has been synchronized with the second audio, from the synchronization processing unit 63 (FIG. 10).

The smoothed spectrogram calculating unit 261 calculates a smoothed spectrogram of the first audio supplied thereto, in the same way as with the smoothed spectrogram calculating unit 221 in FIG. 20, and supplies this to the common peak detecting unit 263.

The smoothed spectrogram calculating unit 262 is supplied with the second audio which has been synchronized with the first audio, from the synchronization processing unit 63.

The smoothed spectrogram calculating unit 262 calculates a smoothed spectrogram of the second audio supplied thereto, in the same way as with the smoothed spectrogram calculating unit 222 in FIG. 20, and supplies this to the common peak detecting unit 263.

The common peak detecting unit 263 detects the first and second spectrum peaks serving as common peaks which are peaks of common signal components, from the smoothed spectrogram of the first audio from the smoothed spectrogram calculating unit 261 and the smoothed spectrogram of the second audio from the smoothed spectrogram calculating unit 262, in the same way as with the common peak detecting unit 223 in FIG. 20, and supplies common peak information representing the frequency and magnitude of the common peaks to the common signal component suppressing units 273 and 274.

The spectrogram calculating unit 271 is supplied with the first audio from the synchronization processing unit 63 (FIG. 10). The spectrogram calculating unit 271 calculates the spectrogram of the first audio in the same way as with the spectrogram calculating unit 111 in FIG. 12, and supplies this to the common signal component suppressing unit 273.

The spectrogram calculating unit 272 is supplied with the second audio from the synchronization processing unit 63. The spectrogram calculating unit 272 calculates the spectrogram of the second audio in the same way as with the spectrogram calculating unit 112 in FIG. 12, and supplies this to the common signal component suppressing unit 274.

The common signal component suppressing unit 273, based on the common peak information from the common peak detecting unit 263, suppresses the common signal components included in the spectrogram of the first audio by setting to zero the frequency component of the first spectrum peak frequency serving as the common peak in the spectrogram of the first audio from the spectrogram calculating unit 271, indicated by common peak information, or the like, and supplies a spectrogram of first suppressed audio which is the first audio of which the common signal component has been suppressed, to the inverse transform unit 275.

Note that the common signal component generally extends from the frequency of the first spectrum peak serving as a common peak which the common peak information indicates, as the center thereof, so suppressing of the common signal component at the common signal component suppressing unit 273 can be performed by setting to zero the frequency component of a frequency band corresponding to ¼ to ½ of a half-note centered on the frequency indicated by the common peak information.

The common signal component suppressing unit 274, based on the common signal component from the common peak detecting unit 263, suppresses the common signal components included in the spectrogram of the second audio from the spectrogram calculating unit 272 in the same way as with the common signal component suppressing unit 273, and supplies a spectrogram of second suppressed audio which is the second audio of which the common signal component has been suppressed, to the inverse transform unit 276.

The inverse transform unit 275 is supplied with the spectrogram of the first suppressed audio from the common signal component suppressing unit 273, and is also supplied with the same first audio (original first audio) supplied to the spectrogram calculating unit 271.

The inverse transform unit 275 obtains the phase properties of the original first audio, and performs short term Fourier transform using the phase properties and the spectrogram (amplitude properties) of the first suppressed audio from the common signal component suppressing unit 273, thereby performing inverse transform of the phase properties of the original first audio and the spectrogram of the first suppressed audio, which are frequency region signals, into first suppressed audio temporal region signals, and outputs to the average signal calculating unit 277.

The inverse transform unit 276 is supplied with the spectrogram of the second suppressed audio from the common signal component suppressing unit 274, and is also supplied with the same second audio (original second audio) supplied to the spectrogram calculating unit 272.

The inverse transform unit 276 obtains the phase properties of the original second audio, and performs short term Fourier transform using the phase properties and the spectrogram (amplitude properties) of the second suppressed audio from the common signal component suppressing unit 274, thereby performing inverse transform of the phase properties of the original second audio and the spectrogram of the second suppressed audio, which are frequency region signals, into second suppressed audio temporal region signals, and outputs to the average signal calculating unit 278.

Now, in the event that the first audio has, for example, multiple channels such as a left channel and right channel or the like, the common signal suppressing unit 260 performs the common signal suppressing processing for each channel. In this case, first suppressed audio of multiple channels is supplied from the inverse transform unit 275 to the average signal calculating unit 277.

In the same way, in the event that the second audio has multiple channels, the common signal suppressing unit 260 performs the common signal suppressing processing for each channel. In this case, second suppressed audio of multiple channels is supplied from the inverse transform unit 276 to the average signal calculating unit 278.

The first suppressed audio supplied from the inverse transform unit 275 to the average signal calculating unit 277 is signals of which the common signal components of the original first audio have been suppressed, with the signals (component) of the part included in the original first audio being generally dominant.

In the same way, the second suppressed audio supplied from the inverse transform unit 276 to the average signal calculating unit 278 is such that the signals of the part included in the original second audio is generally dominant.

Note that with the common signal suppressing unit 260, the common signal suppressing processing can be performed in a form straddling channels (by multi-channel processing) rather than for each channel.

Also, in the event that metadata of part information, for example, exists as prior information regarding the first audio and second audio, first suppressed audio and second suppressed audio with the signals of the part even more dominant can be obtained by using the prior information and reducing suppression of frequency components characteristic of the part which the part information indicates, in the common signal suppressing processing, for example.

In order to make multiple channels of the first suppressed audio from the inverse transform unit 275 into monaural, the average signal calculating unit 277 obtains an average value of the multiple channels (hereinafter also referred to as first suppressed audio average signals), and supplies to the basic frequency estimating unit 279.

In order to make multiple channels of the second suppressed audio from the inverse transform unit 276 into monaural, the average signal calculating unit 278 obtains an average value of the multiple channels (hereinafter also referred to as second suppressed audio average signals), and supplies to the basic frequency estimating unit 280.

Now, in the event that the first audio is single-channel signals, the first suppressed audio average signals output at the average signal calculating unit 277 are equal to the first suppressed audio which is the input to the average signal calculating unit 277. This is true for the second suppressed audio average signals as well.

The basic frequency estimating unit 279 estimates the basic frequency (pitch frequency) of the first suppressed audio average signals from the average signal calculating unit 277 in increments of frames of predetermined temporal length (e.g., several tens of milliseconds, or the like), and supplies this to the vocal score calculating unit 281.

The basic frequency estimating unit 280 estimates the basic frequency of the second suppressed audio average signals from the average signal calculating unit 278 for each frame, in the same way as with the basic frequency estimating unit 279, and supplies this to the vocal score calculating unit 282. As for an estimation method of basic frequency of signals, a method of detecting the smallest frequency of spectrum peaks of the spectrum obtained by FFT (fast Fourier transform) of signals, or the like, can be employed.

The vocal score calculating unit 281 calculates a vocal score representing the vocal-likeness of the first suppressed audio (the degree of which the first suppressed audio is speech (voice)), based on the basic frequency for each frame of the first suppressed audio average signals from the basic frequency estimating unit 279, and supplies to the part deciding unit 283.

Now, with regard to vocals (speech or singing), there is a tendency for transition of basic frequency between two sounds to be smooth as compared to instrument sounds, and to be an ambiguous basic frequency not belonging to any note in the scale at the starting point and ending point of a phrase.

Accordingly, the vocal score calculating unit 281 compares the basic frequency of each frame in the first suppressed audio average signals with the frequencies corresponding to the Western 12-tone scale, takes frames of which the difference in basic frequency as to frequencies closest to the basic frequency out of the frequencies corresponding to the Western 12-tone scale is, for example, ¼ step or greater, as vocal frames of which the vocal is dominant, and counts the number of the vocal frames.

The vocal score calculating unit 281 then divides the number of vocal frames by the number of frames of the first suppressed audio average signals (normalizes), and supplies the division value obtained as a result thereof to the part deciding unit 283 as the vocal score of the first suppressed audio.

The vocal score calculating unit 282 calculates the vocal score of the second suppressed audio based on the basic frequency for each frame of the second suppressed audio average signals from the basic frequency estimating unit 280, in the same way as with the vocal score calculating unit 281, and supplies to the part deciding unit 283.

The part deciding unit 283 estimates the parts of each of the first suppressed audio and second suppressed audio (the parts of each of the first audio and second audio) based on the vocal scores from the vocal score calculating units 281 and 282, and outputs part information representing each of the parts.

That is to say, the part deciding unit 283 decides the part of the audio of the first (suppressed) audio and second (suppressed) audio of which the vocal score is greater to be a vocal part (estimates the part of the audio of which the vocal score is greatest to be the vocal part), and also decides parts of the other to be a non-vocal part, and outputs part information representing each of the first audio and the second audio.

FIG. 27 is a flowchart for describing processing which the part estimating unit 231 in FIG. 26 performs (part estimating processing).

In step S241, the smoothed spectrogram calculating unit 261, spectrogram calculating unit 271, and inverse transform unit 275 receive the first audio from the synchronization processing unit 63 (FIG. 10).

Further, in step S241, the smoothed spectrogram calculating unit 262, spectrogram calculating unit 272, and inverse transform unit 276 receive the second audio from the synchronization processing unit 63, and the processing advances to step S242.

In step S242, the smoothed spectrogram calculating unit 261 and spectrogram calculating unit 271 calculate the spectrogram of the first audio, and also the smoothed spectrogram calculating unit 262 and spectrogram calculating unit 272 calculate the spectrogram of the second audio.

Further, in step S242, the smoothed spectrogram calculating unit 261 smoothes the spectrogram of the first audio, thereby calculating a smoothed spectrogram of the first audio, and the smoothed spectrogram calculating unit 262 smoothes the spectrogram of the second audio, thereby calculating a smoothed spectrogram of the second audio.

The smoothed spectrogram of the first audio calculated at the smoothed spectrogram calculating unit 261, and the smoothed spectrogram of the second audio calculated at the smoothed spectrogram calculating unit 262, are supplied to the common peak detecting unit 263, the spectrogram of the first audio calculated at the spectrogram calculating unit 271 is supplied to the common signal component suppressing unit 273, and the spectrogram of the second audio calculated at the spectrogram calculating unit 272 is supplied to the common signal component suppressing unit 274, respectively, and the processing advances from step S242 to step S243.

In step S243, the common peak detecting unit 263 detects the first spectrum peak from the smoothed spectrogram of the first audio from the smoothed spectrogram calculating unit 261, along with the second spectrum peak from the smoothed spectrogram of the second audio from the smoothed spectrogram calculating unit 262, and the processing advances to step S244.

In step S244, the common peak detecting unit 263 detects, of the first and second spectrum peaks, first and second spectrum peaks at close positions to each other, as common peaks which are peaks of common signal components, and supplies common peak information representing the frequency and size of the first and second spectrum peaks which are the common peaks to the common signal component suppressing units 273 and 274, and the processing advances to step S245.

In step S245, the common signal component suppressing unit 273, based on the common peak information from the common peak detecting unit 263, suppresses the common signal components included in the spectrogram of the first audio by setting to zero the frequency component of the first spectrum peak frequency serving as the common peak in the spectrogram of the first audio from the spectrogram calculating unit 271, indicated by common peak information, or the like, and supplies a spectrogram of first suppressed audio which is the first audio of which the common signal component has been suppressed, to the inverse transform unit 275.

Further, in step S245, the common signal component suppressing unit 274, based on the common signal components from the common peak detecting unit 263, suppresses the common signal components included in the spectrogram of the second audio from the spectrogram calculating unit 272 in the same way as with the common signal component suppressing unit 273, and supplies a spectrogram of second suppressed audio which is the second audio of which the common signal component has been suppressed, to the inverse transform unit 276, and the processing advances to step S246.

In step S246, the inverse transform unit 275 obtains (acquires) phase properties of the first audio supplied thereto, the inverse transform unit 276 obtains phase properties of the second audio supplied thereto, and the processing advances to step S247.

In step S247, the inverse transform unit 275 performs inverse transform of the phase properties of the first audio and the spectrogram of the first suppressed audio (amplitude properties) from the common signal component suppressing unit 273, into first suppressed audio which is temporal region signals, and supplies to the average signal calculating unit 277.

Further, in step S247, the inverse transform unit 276 performs inverse transform of the phase properties of the second audio and the spectrogram of the second suppressed audio (amplitude properties) from the common signal component suppressing unit 274, into second suppressed audio which is temporal region signals, supplies to the average signal calculating unit 278, and the processing advances to step S248.

In step S248, the average signal calculating unit 277 obtains the first suppressed audio average signals which is the average value of multiple channels of first suppressed audio from the inverse transform unit 275, and supplies to the basic frequency estimating unit 279.

Further, in step S248, the average signal calculating unit 278 obtains the second suppressed audio average signals which is the average value of multiple channels of second suppressed audio from the inverse transform unit 276, supplies to the basic frequency estimating unit 280, and the processing advances to step S249.

In step S249, the basic frequency estimating unit 279 estimates the basic frequency of the first suppressed audio average signals from the average signal calculating unit 277, and supplies to the vocal score calculating unit 281.

Further, in step S249, the basic frequency estimating unit 280 estimates the basic frequency of the second suppressed audio average signals from the average signal calculating unit 278, supplies to the vocal score calculating unit 282, and the processing advances to step S250.

In step S250, the vocal score calculating unit 281 calculates the vocal score of the first (suppressed) audio based on the basic frequency of the first suppressed audio average signals from the basic frequency estimating unit 279, and supplies to the part deciding unit 283.

Further, in step S250, the vocal score calculating unit 282 calculates the vocal score of the second (suppressed) audio based on the basic frequency of the second suppressed audio average signals from the basic frequency estimating unit 280, supplies to the part deciding unit 283, and the processing advances to step S251.

In step S251, the part deciding unit 283 estimates which part of the first audio and second audio is a vocal part and which is a non-vocal part, based on the vocal scores from the vocal score calculating units 281 and 282, outputs part information representing the parts of each of the first audio and second audio, and the part estimating processing ends.

Note that in FIG. 27, the processing of steps S242 through S247 is the common signal suppressing processing for suppressing common signal components from the first audio and second audio, that is performed at the common signal suppressing unit 260 (FIG. 26).

### Second Configuration Example of Volume Ratio Calculating Unit 232

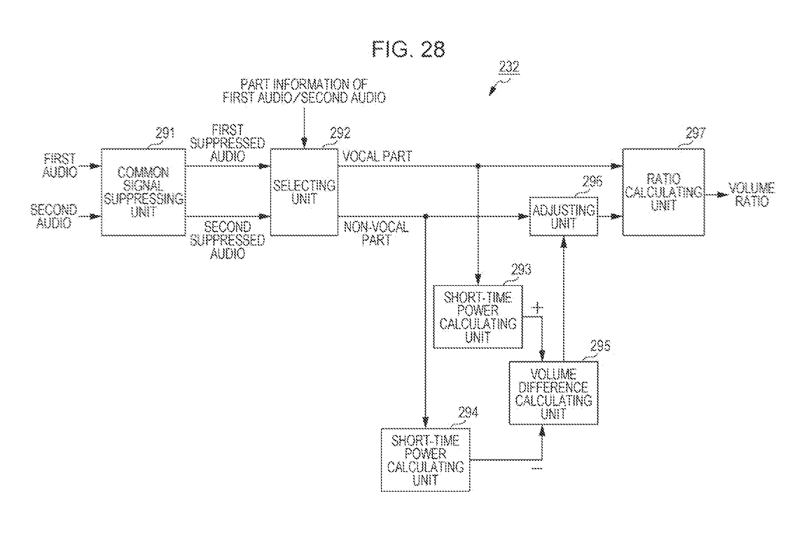

FIG. 28 is a block diagram illustrating a second configuration example of the volume ratio calculating unit 232 in FIG. 23. In FIG. 28, the volume ratio calculating unit 232 includes a common signal suppressing unit 291, a selecting unit 292, a short-time power calculating unit 293, a short-time power calculating unit 294, a volume difference calculating unit 295, an adjusting unit 296, and a ratio calculating unit 297.

The common signal suppressing unit 291 is supplied with the first audio and second audio from the synchronization processing unit 63 (FIG. 10). The common signal suppressing unit 291 is configured in the same way as with the common signal suppressing unit 260 in FIG. 26, performs common signal suppressing processing to suppress the common signal components of each of the first audio and second audio from the synchronization processing unit 63, and supplies the first suppressed audio and second suppressed audio obtained as a result thereof to the selecting unit 292.

The selecting unit 292 is supplied with the first suppressed audio and second suppressed audio from the common signal suppressing unit 291, and also is supplied with part information of each of the first audio and second audio, from the part estimating unit 231 (FIG. 23). The selecting unit 292 selects, from the first suppressed audio and second suppressed audio from the common signal suppressing unit 291, the audio of the vocal part (one of the first suppressed audio and second suppressed audio), based on the part information from the part estimating unit 231, and supplies to the short-time power calculating unit 293 and ratio calculating unit 297.

Further, the selecting unit 292 selects, from the first suppressed audio and second suppressed audio from the common signal suppressing unit 291, the audio of the non-vocal part (the other of the first suppressed audio and second suppressed audio), based on the part information from the part estimating unit 231, and supplies to the short-time power calculating unit 294 and adjusting unit 296.

The short-time power calculating unit 293 calculates the volume (e.g., the dB value in terms of decibels) for the audio of the vocal part from the selecting unit 292, in increments of frames of predetermined temporal length (e.g., several tens of milliseconds, or the like), and supplies this to the volume difference calculating unit 295.

The short-time power calculating unit 294 calculates the volume of the audio of the non-vocal part from the selecting unit 292 in increments of frames, in the same way as with the short-time power calculating unit 293, and supplies to the volume difference calculating unit 295.

The volume difference calculating unit 295 subtracts the volume of the audio of the non-vocal part from the short-time power calculating unit 294 from the volume of the audio of the vocal part from the short-time power calculating unit 293, thereby obtaining volume difference between the volume of the audio of the vocal part and the volume of the audio of the non-vocal part, for each frame, which is supplied to the adjusting unit 296.

The adjusting unit 296 obtains an adjustment amount b for adjusting the volume of the audio of the non-vocal part, for example, which is one of the vocal part and non-vocal part, such that the volume ratio of the audio of the vocal part and non-vocal part in the composited audio composited of the first audio and second audio, i.e., the composited audio where the audio of the vocal part and the audio of the non-vocal part have been composited, is a suitable volume ratio, based on the volume difference for each frame from the volume difference calculating unit 295.

Specifically, the adjusting unit 296 obtains the adjustment amount b following Expression (2), for example, where the volume difference (subtraction value obtained by subtracting the volume of audio of the non-vocal part from the volume of audio of the vocal part) of a t'th frame between the audio of the vocal part and the audio of the non-vocal part is expressed as Pd(t).

b=minₜ{Pd(t)}−γ (2)

where minₜ{Pd(t)} represents the smallest value of the volume difference Pd(t) for each frame, and γ is a predetermined constant such as 3 dB or the like, for example.

The adjusting unit 296 adjusts the volume of the audio of the non-vocal part from the selecting unit 292 by the adjustment amount b, and supplies the audio of the non-vocal part after adjustment to the ratio calculating unit 297.

Now, with the adjustment amount b in Expression (2), the audio of the non-vocal part is adjusted so as to be a volume smaller than the audio of the vocal part by at least γ dB normally (if the adjustment amount b is positive, the volume of the audio of the non-vocal part is increased, and if the adjustment amount b is negative, the volume of the audio of the non-vocal part is decreased).

The vocal part will often be singing the melody, and is the most important part. Accordingly, in order for the volume ratio to be decided such that the volume of the audio of the non-vocal part does not exceed the volume of the audio of the vocal part, such that the vocal can be clearly heard in the composited audio, the adjusting unit 296 obtains an adjustment amount b following Expression (2) such that the volume of the audio of the non-vocal part after adjustment of volume following the adjustment amount b is at least smaller than the volume of the audio of the vocal part by γ dB.

The audio of the non-vocal part after adjustment of volume by the adjusting unit 296 is made to be smaller than the volume of the audio of the vocal part by at least γ dB, so it can be expected that with such a composited audio of the audio of the non-vocal part and audio of the vocal part having been composited, the audio of the vocal part can be heard without being drowned out by the audio of the non-vocal part.

The ratio calculating unit 297 obtains the overall volume (dB) of the vocal part from the selecting unit 292, and the overall volume (dB) of the audio of the non-vocal part after adjustment from the adjusting unit 296.

The ratio calculating unit 297 then calculates and outputs the volume ratio for when compositing the first audio and second audio, from the volume of the audio of the vocal part and the volume of the audio of the non-vocal part.

That is to say, the ratio calculating unit 297 calculates and outputs a volume ratio which is the ratio between the value of the first audio which is one of the volume of the audio of the vocal part and the volume of the audio of the non-vocal part after adjustment, and the value of the second audio which is the other of the volume of the audio of the vocal part and the volume of the audio of the non-vocal part after adjustment.

Note that in the event that three or more contents are contents to be composited, with one content to be composited of the three or more contents to be composited including audio of the vocal part, and the remaining two or more contents to be composited include audio of non-vocal parts, the volume ratio calculating unit 232 in FIG. 28 independently obtains volume ratio regarding each of the audio of non-vocal parts in the two or more contents to be composited, using the audio of the vocal part.

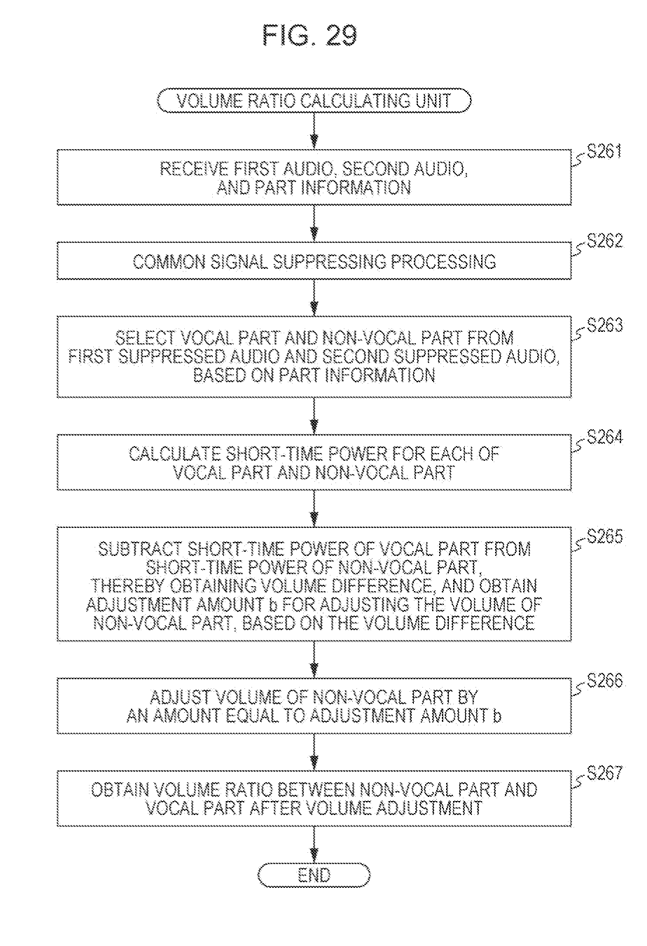

FIG. 29 is a flowchart for describing processing of the volume ratio calculating unit 232 in FIG. 28 (volume ratio calculating processing).

In step S261, the common signal suppressing unit 291 receives the first audio and second audio from the synchronization processing unit 63 (FIG. 10), and the selecting unit 292 receives the part information from the part estimating unit 231 (FIG. 23), and the flow proceeds to step S262.

In step S262, the common signal suppressing unit 291 performs common signal suppressing processing for suppressing the common signal components of the first audio and second audio from the synchronization processing unit 63, in the same way as with the common signal suppressing unit 260 in FIG. 26, supplies the first suppressed audio and second suppressed audio obtained as a result thereof to the selecting unit 292, and the processing advances to step S263.

In step S263, the selecting unit 292 selects the audio of the vocal part which is one of the first suppressed audio and second suppressed audio from the common signal suppressing unit 291, and supplies this to the short-time power calculating unit 293 and ratio calculating unit 297.

Further, the selecting unit 292 selects the audio of the non-vocal part which is the other of the first suppressed audio and second suppressed audio from the common signal suppressing unit 291, based on the part information from the part estimating unit 231, supplies this to the short-time power calculating unit 294 and adjusting unit 296, and the processing advances from step S263 to step S264.

In step S264, the short-time power calculating unit 293 calculates the volume (power) of audio of the vocal part from the selecting unit 292, for each frame, and supplies this to the volume difference calculating unit 295, and also the short-time power calculating unit 294 calculates the volume of the audio of the non-vocal part from the selecting unit 292, for each frame, supplies this to the volume difference calculating unit 295, and the processing advances to step S265.

In step S265, the volume difference calculating unit 295 obtains the volume difference between the volume of the audio of the vocal part from the short-time power calculating unit 293 and the volume of the audio of the non-vocal part from the short-time power calculating unit 294, for each frame, and supplies this to the adjusting unit 296.

The adjusting unit 296 obtains an adjustment amount b for adjusting the volume of the audio of the non-vocal part following the above-described Expression (2), based on the volume difference for each frame from the volume difference calculating unit 295, and the processing advances from step S265 to step S266.

In step S266, the adjusting unit 296 adjusts the volume of the audio of the non-vocal part from the selecting unit 292 by the adjustment amount b, supplies the audio of the non-vocal part after adjustment to the ratio calculating unit 297, and the processing advances to step S267.

In step S267, the ratio calculating unit 297 obtains the overall volume of the audio of the vocal part from the selecting unit 292, and the overall volume of the audio of the non-vocal part after adjustment from the adjusting unit 296.

The ratio calculating unit 297 then calculates and outputs, from the volume of the audio of the vocal part and the volume of the audio of the non-vocal part, the volume ratio for when compositing the first audio and second audio, from the volume of the first audio which is one of the volume of the audio of the vocal part and the volume of the audio of the non-vocal part, and the value of the second audio which is the other of the volume of the audio of the vocal part and the volume of the audio of the non-vocal part, and the volume ratio calculating processing ends.

Note that with the optimal volume ratio calculating unit in FIG. 23, the volume ratio can be calculated selectively using the part estimating unit 231 in FIG. 24 or FIG. 26 and selectively using the volume ratio calculating unit 232 of FIG. 25 or FIG. 28.

That is to say, in the event that contents with part information added as metadata and contents with no part information added as metadata coexist in the contents to be composited, the volume ratio can be obtained for the contents to be composited regarding which part information has been added as metadata using the part estimating unit 231 in FIG. 24 and the volume ratio calculating unit 232 in FIG. 25, and obtained for the contents to be composited regarding which part information has not been added as metadata using the part estimating unit 231 in FIG. 26 and the volume ratio calculating unit 232 in FIG. 28.

Second Embodiment of Content Processing System to which the Present Technique has been Applied

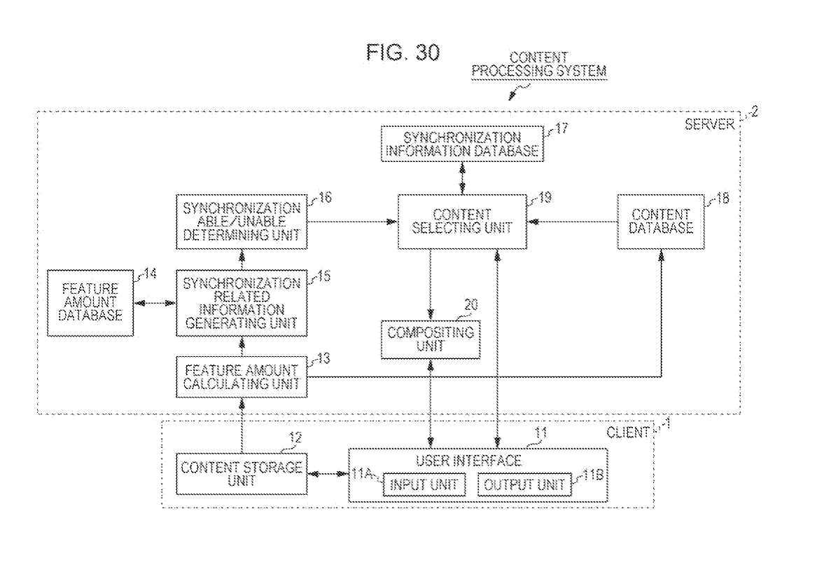

FIG. 30 is a block diagram illustrating a configuration example of a second embodiment of the content processing system to which the present technology has been applied. Note that portions in FIG. 30 corresponding to the case in FIG. 1 are denoted with the same reference numerals, and description thereof in the following description will be omitted as appropriate.

As for the configuration of the content processing system, besides a stand-alone configuration, a cloud computing configuration can be employed such as a client-server system where one function is distributed among multiple devices over a network with the processing being performed collaboratively.

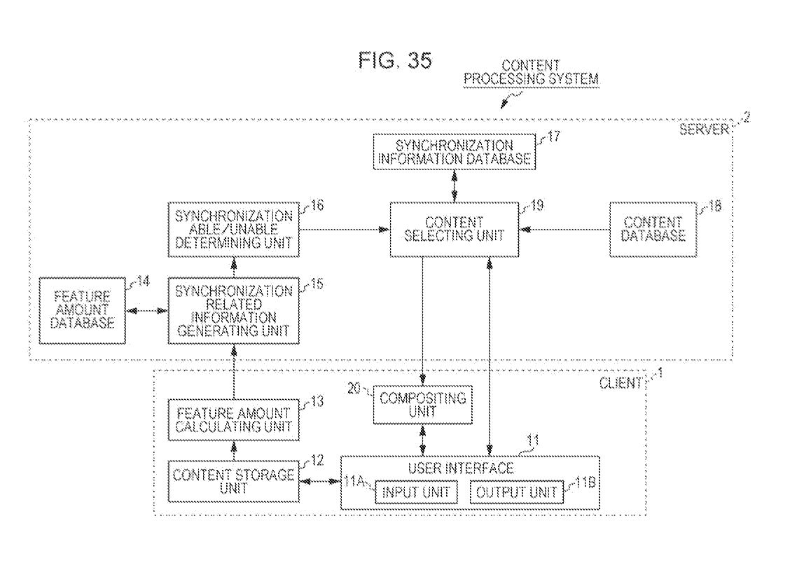

The content processing system in FIG. 30 has a client-server system configuration (which is also true for the content processing system in FIG. 35 to be described later), and can be incorporated in a video sharing service, for example.

In FIG. 30, the content processing system has a client 1 and server 2, with the client 1 and the server 2 being connected by a network such as the Internet or the like. The client 1 is a device which the user can directly operate, and applicable examples include a device connected to a home network using a LAN, a portable terminal such as a smartphone, and other devices capable of communicating with servers on a network.

On the other hand, the server 2 is a server for providing services on a network such as the Internet or the like, and may be a single server or may be a group of multiple servers used for cloud computing. Note that one or more other clients configured in the same way as the client 1 may also be connected to the server 2, but these are omitted from illustration.

In FIG. 30, the client 1 has the user interface 11 and content storage unit 12, and the server 2 has the components of feature amount calculating unit 13 through compositing unit 20.

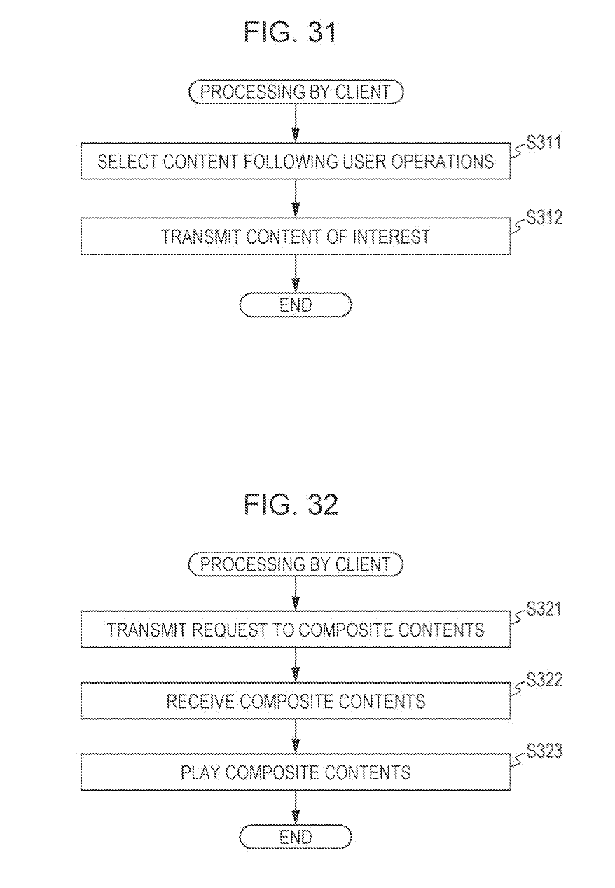

FIG. 31 is a flowchart for describing processing of uploading content to the server 2, which the client 1 of the content processing system in FIG. 30 performs.

In step S311, the client 1 stands by for the user to operate the user interface 11 so as to select contents, the content storage unit 12 selects a content of interest from the stored contents in response to operations of the user interface 11 by the user, and the processing advances to step S312.

In step S312, the client 1 reads out the content of interest from the content storage unit 12, transmits (uploads) this to the server 2, and the client 1 ends processing.

FIG. 32 is a flowchart for describing processing of requesting composited contents, which the client 1 of the content processing system in FIG. 30 performs.

In step S321, the user interface 11 stands by for the user to operate the user interface 11 so as to request playing of composited contents, upon which the user interface 11 transmits a compositing request to request compositing of contents to the content selecting unit 19 of the server 2, and the processing advances to step S322.

In step S322, the user interface 11 stands by for composited contents to be transmitted from the server 2 in response to the compositing request in step S321, receives the composited contents from the compositing unit 20 of the server 2, and the processing advances to step S323.

In step S323, the user interface 11 plays the composited contents from the compositing unit 20 of the server 2, i.e., performs display of images included in the composited contents and output of audio included in the composited contents, and the client 1 ends processing.

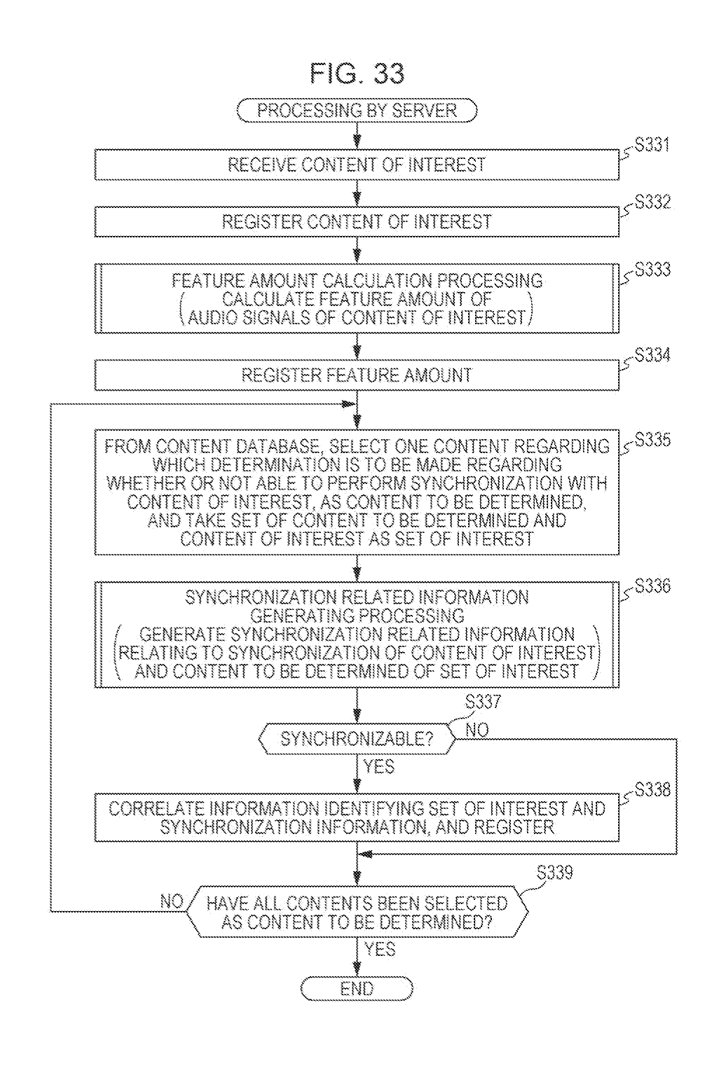

FIG. 33 is a flowchart for describing processing which the server 2 performs in response to the processing which the client 1 in FIG. 30 performs in FIG. 31.

In step S331, the feature amount calculating unit 13 of the server 2 receives a content of interest transmitted from the client 1 in step S312 in FIG. 31, and the processing advances to step S332.

In steps S332 through S339, processing the same as with the steps S12 through S19 in the content registration processing in FIG. 2 is performed, and the server 2 ends processing.

Accordingly, with the processing in FIG. 33, the content of interest is registered in the content database 18, and the audio feature amount of the content of interest is registered in the feature amount database 14.

Further, regarding registered content of the registered content in the content database 18, of which synchronization can be performed with the content of interest, synchronization information for synchronization with the content of interest is registered in the synchronization information database 17.

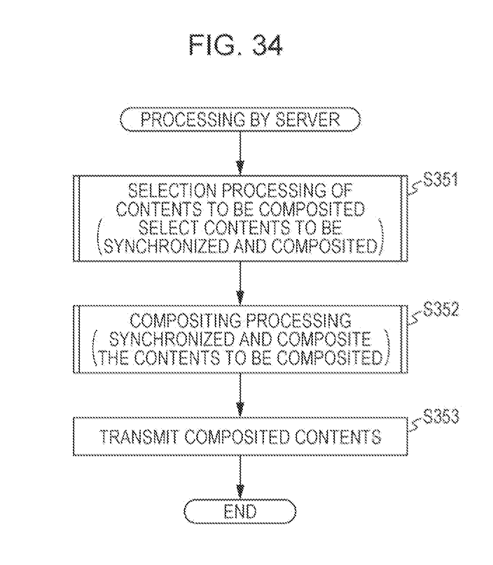

FIG. 34 is a flowchart for describing processing which the server 2 performs in response to the processing which the client 1 in FIG. 30 performs in FIG. 32.

In step S321 in FIG. 32, upon a compositing request being transmitted from the client 1 to the server 2, in step S351 the content selecting unit 19 of the server 2 performs content to be composited selection processing in the same way as with step S31 in FIG. 3 in response to the compositing request from the client 1.

Now, with the content to be composited selection processing in step S351, multiple contents to be used for generating the composited contents are selected from the registered contents stored in the content database 18, as contents to be composited, as described with FIG. 8 and FIG. 9.

The content selecting unit 19 reads out from the synchronization information database 17 synchronization information for synchronizing the contents to be composited, obtained by the content to be composited selection processing, with each other (synchronization information for compositing), supplies this to the compositing unit 20 along with the contents to be composited, and the processing advances from step S351 to step S352.

In step S352, the compositing unit 20 performs compositing processing to generate composited content, using the synchronization information for compositing from the content selecting unit 19, to synchronize and composite the contents to be composited, also from the content selecting unit 19, in the same way as with step S32 in FIG. 3, and the processing advances to step S353.

In step S353, the compositing unit 20 transmits the composited contents obtained by the compositing processing to the client 1, and the server 2 ends the processing.

With the content processing system in FIG. 30, the server 2 has the compositing unit 20, and the composited contents are generated at the server 2, so composited contents can be generated using contents uploaded from the client 1 to the server 2, and registered contents stored in the content database 18 beforehand, as contents to be composited, or using only registered contents stored in the content database 18 beforehand as contents to be composited.

Third Embodiment Of Content Processing System to which the Present Technique has been Applied

FIG. 35 is a block diagram illustrating a configuration example of a third embodiment of the content processing system to which the present technology has been applied. Note that portions in FIG. 35 corresponding to the cases in FIG. 1 or FIG. 30 are denoted with the same reference numerals, and description thereof in the following description will be omitted as appropriate.

The configuration of the content processing system in FIG. 35 is a client-server system configuration having a client 1 and server 2 with the client 1 and server 2 connected via network, in the same way as with the case in FIG. 30.

Note however, that in FIG. 35, the client 1 differs from the client 1 in FIG. 30 having only the user interface 11 and content storage unit 12, with regard to the point of having the feature amount calculating unit 13 and compositing unit 20 besides the user interface 11 and content storage unit 12.

Further, with FIG. 35, the server 2 differs from the server 2 in FIG. 30 which has the components of feature amount calculating unit 13 through compositing unit 20 including the feature amount calculating unit 13 and compositing unit 20, with regard to the point of having the components of feature amount database 14 through content selecting unit 19 but not having the feature amount calculating unit 13 and compositing unit 20.

Note that we will say that with the embodiment in FIG. 35, contents which can be used as contents to be composited from a licensing perspective are registered in the content database 18 as registered contents, and further, audio feature amounts of contents stored (registered) in the content database 18 are registered in the feature amount database 14.

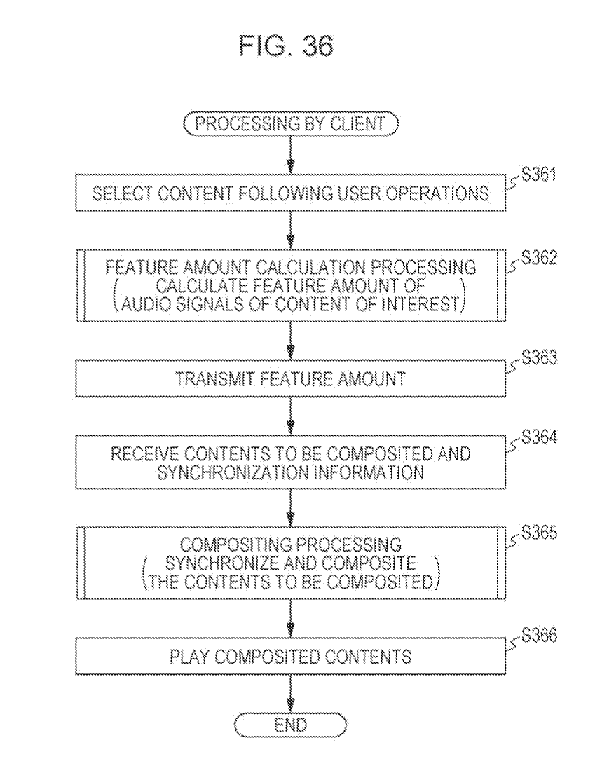

FIG. 36 is a flowchart for describing processing performed at the client 1 of the content processing system in FIG. 35.

In step S361, the user operating the user interface 11 so as to select a content is awaited, upon which the content storage unit 12 selects a content of interest from the contents stored therein, which is supplied to the feature amount calculating unit 13, and the processing advances to step S362.

In step S362, in the same way as with step S13 in FIG. 2, the feature amount calculating unit 13 performs feature amount calculating processing to calculate audio feature amount of the audio included in the content of interest from the content storage unit 12, and the processing advances to step S363.

In step S363, the feature amount calculating unit 13 transmits (uploads) the audio feature amount of the content of interest obtained by the feature amount processing to the synchronization related information generating unit 15 of the server 2, and the processing advances to step S364.

In step S364, the compositing unit 20 of the client 1 receives contents to be composited and synchronization information for compositing, transmitted from the content selecting unit 19 of the server 2, as described later.

The compositing unit 20 then reads out the content of interest from the content storage unit 12 via the user interface 11, includes this as content to be composited in the content to be composited from the server 2, and the processing advances from step S364 to S365.

Now, synchronization information transmitted from the server 2 to the client 1 in step S364 is synchronization information for synchronizing the content to be composited with each other, including the content of interest, which will be described later.

In step S365, the compositing unit 20 uses the synchronization information for compositing from (the content selecting unit 19 of) the server 2, to synchronize and composite the content to be composited including the content of interest, and performs compositing processing to generate composited contents in the same way as with step S32 in FIG. 3.

The compositing unit 20 then supplies the composited content obtained by the compositing processing to the user interface 11, and the processing advances from step S365 to step S366.

In step S366, the user interface 11 plays the composited content from the compositing unit 20, that is to say, performs display of images included in the composited content and output of audio included in the composited content, and the client 1 ends the processing.

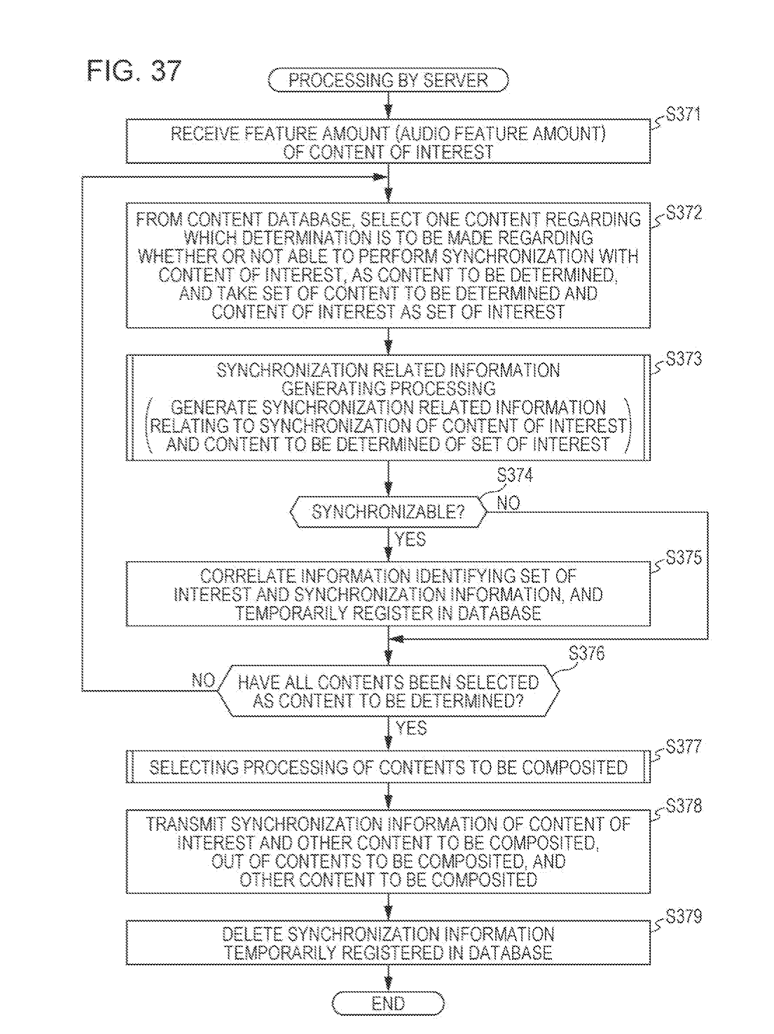

FIG. 37 is a flowchart for describing processing which the server 2 performs in accordance with the processing in FIG. 36 performed by the client 1 in FIG. 30.

In step S371, the synchronization related information generating unit 15 of the server 2 receives the audio feature amount of the content of interest transmitted from the client 1 in step S363 in FIG. 36, and the processing advances to step S372.

In step S372, the synchronization related information generating unit 15 selects, from registered contents stored in the content database 18, one of the contents not yet selected as content to be determined regarding determination of whether or not synchronization can be made with the content of interest, as the content to be determined, takes the set of the content of interest and the content to be determined as a set of interest, and the processing advances to step S373.

In step S373, regarding the set of interest, the synchronization related information generating unit 15 performs synchronization related information generating to generate synchronization related information relating to synchronizing between the content of interest and the content to be determined, based on the audio feature amount of the content of interest in the set of interest from the client 1, and on the audio feature amount of the content to be determined in the set of interest stored in the feature amount database 14, in the same way as with the step S16 in FIG. 2.

The synchronization related information generating unit then supplies synchronization related information (of the content of interest and content to be determined) of the set of interest, obtained from the synchronization related information, to the synchronization able/unable determining unit 16, and the processing advances from step S373 to step S374.

In step S374, the synchronization able/unable determining unit 16 performs determination of whether or not synchronization between the audio of the content of interest and the content to be determined can be performed, based on synchronization able/unable level included in the synchronization related information of the set of interest from the synchronization related information generating unit 15, in the same way as with step S17 in FIG. 2.

In step S374, in the event that determination is made that synchronization can be performed between (the audio of) the content of interest and the content to be determined, the processing advances to step S375, where the synchronization able/unable determining unit 16 supplies (information identifying) the set of interest of the content of interest and registered content regarding which determination has been made that synchronization can be performed to the content selecting unit 19, along with the synchronization information included in the synchronization related information of the set of interest, that is supplied from the synchronization related information generating unit 15.

Further, in step S375, the content selecting unit 19 correlates the synchronization information of the set of interest from the synchronization able/unable determining unit 16 with information identifying the set of interest, also from the synchronization able/unable determining unit 16, supplies this to the synchronization information database 17 for temporary registration, and the processing advances to step S376.

On the other hand, in step S374, in the event that determination is made that synchronization between the content of interest and the registered content is not performable, the flow skips step S375 and advances to step S376.

In step S376, the synchronization related information generating unit 15 determines whether all registered contents stored in the content database 18 have been selected as content to be determined.

In the event that determination is made in step S376 that not all registered contents stored in the content database 18 have been selected as content to be determined, i.e., in the event that there is a content of the registered contents stored in the content database 18 that has not yet been selected as content to be determined, the flow returns to step S372, and subsequently, the same processing is repeated.

Also, in the event that determination is made in step S376 that all registered contents stored in the content database 18 have been selected as content to be determined, i.e., in the event that determination regarding whether or not synchronization can be performed has been made between the content of interest and all registered contents stored in the content database 18, and further, synchronization information for synchronization between the content of interest and registered contents regarding which synchronization can be performed with the content of interest has been temporarily registered in the synchronization information database 17, the processing advances to step S377, where the content selecting unit 19 performs content to be composited selection processing, of selecting multiple contents to be used for generating of composited content as content to be composited, from the registered contents stored in the content database 18, in accordance with user operations of the user interface 11, in the same way as with step S31 in FIG. 3.

Now, with the content processing system in FIG. 35, the content of interest of which the audio feature amount is transmitted from the feature amount calculating unit 13 of the client 1 to the server 2 is included in the content to be composited.

Accordingly, for the content to be composited selection processing, there is the independent content to be composited selection processing in FIG. 8, and the consecutive content to be composited selection processing in FIG. 9; and with the content to be composited selection processing in step S377 with the content processing system in FIG. 35, the consecutive content to be composited selection processing in FIG. 9, where the content of interest is selected as content to be composited, is performed.

Upon the content selecting unit 19 selecting the content to be composited including the content of interest by way of the content to be composited selection processing in step S377, the processing advances to step S378.

In step S378, the content selecting unit 19 reads out from the synchronization information database 17 synchronization information to synchronize the content of interest which is a content to be composited with another content to be composited (a content to be composited other than the content of interest) synchronization information for synchronizing between contents to be composited including the content of interest, transmits this to the compositing unit 20 of the client 1 along with the content to be composited stored in the content database 18 as registered content, and the processing advances to step S379.

Now, with the embodiment in FIG. 35, audio feature amount of the content of interest is transmitted from the client 1 to the server 2, rather than the data of the content of interest itself, and the content of interest is not registered in the content database 18 at the server 2.

Accordingly, the content of interest is not included in the content to be composited transmitted from the content selecting unit 19 of the server 2 to the client 1.

Accordingly, as described with FIG. 36, with the client 1, at the compositing unit 20 the content of interest is read out from the content storage unit 12 via the user interface 11 and included in the content to be composited from the server 2 as a content to be composited.

In step S379, the content selecting unit 19 deletes from the synchronization information database 17 the synchronization information temporarily registered in a manner correlated with the set of content of interest and registered content in step S375 (hereinafter also referred to as synchronization information regarding content of interest), and the server 2 ends the processing.

That is to say, with the embodiment in FIG. 35, at the server 2 the content of interest is not registered in the content database 18, so no client other than the client 1 storing the content of interest can generate a composited content using the content of interest as a content to be composited.

Accordingly, the synchronization information regarding the content of interest is not used for generating composited content at clients other than the client 1, and accordingly is deleted at the server 2 after having been provided (transmitted) to the client 1.

Thus, with the content processing system in FIG. 35, the client 1 has a feature amount calculating unit 13 and compositing unit 20, and calculation of audio feature amount of the content of interest and generating of composited content is performed at the client 1.

Also, with the processing system in FIG. 35, the content of interest itself is not transmitted from the client 1 to the server 2, and composited content is generated using the content of interest stored in the content storage unit 12 of the client 1 as a content to be composited, besides registered content stored in the content database 18 of the server 2.

With the processing system in FIG. 35, the content of interest itself is not uploaded to the server 2, and accordingly is not registered in the content database 18 as a registered content, which is useful in a case of generating composited content using, for the content of interest, private content regarding which disclosure to the general public is undesirable, content regarding which upload of the content itself or registration to the content database 18 is difficult due to license related issues, and so forth, and including such a content of interest in the content to be determined.

Moreover, with the content processing system in FIG. 35, the load on the server 2 can be lightened as compared with the content processing system in FIG. 30.

### Description of Computer Using Present Technology

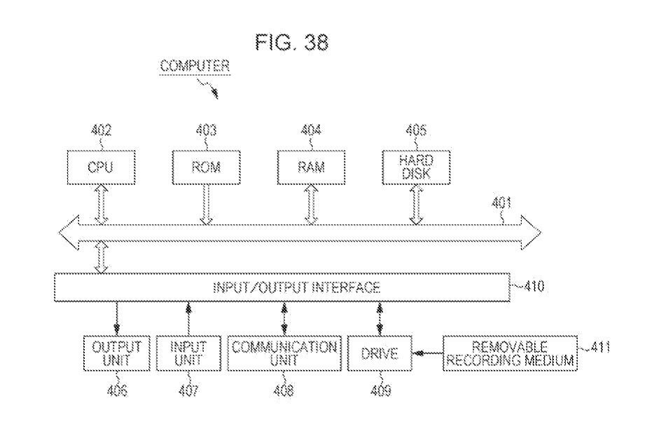

The above-described series of processing can be carried out by hardware and/or by software. In a case of carrying out the series of processing by software, a program making up that software is installed in a general-use computer or the like. Now, FIG. 38 illustrates a configuration example of an embodiment of a computer to which a program executing the above-described series of processing is installed.

The program can be recorded beforehand in a hard disk 405 or ROM 403 serving as a recording medium built into the computer. Alternatively, the program can be stored (recorded) in a removable recording medium 411. A removable recording medium 411 of this sort can be provided as so-called packaged software. Examples of the removable recording medium 411 include flexible disks, CD-ROM (Compact Disc Read Only Memory), MO (Magneto Optical) discs, DVD (Digital Versatile Disc), magnetic disks, semiconductor memory, and so forth.

Note that the program can be downloaded to the computer via a communication network or broadcasting network, and installed in the built-in hard disk 405, besides being installed in the computer from a removable recording medium 411 such as described above. That is to say, the program can be wirelessly transferred to the computer via a digital satellite broadcasting satellite or transferred to the computer by cable via a network such as a LAN (Local Area Network) or the Internet or the like, from a download site, for example.

The computer has a CPU (Central Processing Unit) 402 built in, with an input/output interface 410 connected to the CPU 402 via a bus 401.

Upon a command being input via the input/output interface 410 by the user operating an input unit 407 or the like, the CPU 402 follows this to execute the program stored in ROM (Read Only Memory) 403. Alternatively, the CPU 402 loads the program stored in the hard disk 405 to RAM (Random Access Memory) 404 so as to be executed.

Accordingly, the CPU 402 performs processing following the above-described flowchart, or processing performed by the configuration of the block diagrams described above. The CPU 402 then outputs the processing results thereof from an output unit 406 via the input/output interface 410, or transmits from a communication unit 408, or further records in the hard disk 405, or the like, for example, as appropriate.

Note that the input unit 407 is configured of a keyboard, mouse, microphone, and so forth. Also, the output unit 406 is configured of an LCD (Liquid Crystal Display), speaker, and so forth.

Now, with the Present Specification, the processing which the computer performs according to the program does not have to be performed in the time sequence following the order as described in the flowcharts. That is to say, the processing which the computer performs according to the program includes processing performed in parallel or individually (e.g., parallel processing or object-oriented processing).

Also, the program may be processed by a single computer (processor), or may be processed in a distributed manner by multiple computers. Further, the program may be transferred to and executed by a remote computer.

Further, with the Present Specification, the term system means a collection of multiple components (devices, modules (parts), etc.), and whether or not all components are in the same casing is irrelevant. Accordingly, multiple devices which are housed in separate casings and connected via network, and one apparatus with multiple modules housed in a single casing, are both systems.

Note that embodiments of the present technology are not restricted to the above-described embodiments, and that various modifications can be made without departing from the essence of the present technology.

For example, each step described in the above-described flowchart can be executed at a single device, or alternatively, can be executed in a shared manner among multiple devices. Further, in the event that multiple processes are included in one step, the multiple processes included in that one step can be executed at a single device, or alternatively, can be executed in a shared manner among multiple devices.

Note that the present technology can assume the following configurations.

[1]

An information processing device, including:

a feature amount calculating unit configured to obtain an audio feature amount of audio included in a content including audio;

a synchronization information generating unit configured to generate synchronization information for synchronizing a plurality of content including the same or similar audio signal components, based on the audio feature amount obtained by the feature amount calculating unit; and

a compositing unit configured to generate composited content, where a plurality of contents have been synchronized and composited using the synchronization information generated at the synchronization information generating unit.

[2]

The information processing device according to [1], wherein the compositing unit performs compositing of audio included in the contents to be composited, with the same or similar audio signal components suppressed.

[3]

The information processing device according to [1], wherein the content to be composited include images;

and wherein the compositing unit extracts subjects included in images from the contents to be composited, and composites as to a predetermined background.

[4]

The information processing device according to [1], wherein the content to be composited include images;

and wherein the compositing unit
composites, in accordance with positioning information indicating positioning of images, images included in the content to be composited in a positioning indicated by the positioning information, and
provides localization to audio included in the contents to be composited, following the positioning information, and composites the audio with the localization provided thereto.
   [5]

The information processing device according to [1], further including:

a volume normalization coefficient calculating unit configured to calculate a volume normalization coefficient to change volume of each of the contents to be composited, such that the levels of the same or similar audio signals components included in the contents to be composited match;

wherein the compositing unit composites audio included in the content to be composited while adjusting volume in accordance with the volume normalization coefficient.

[6]

The information processing device according to [5], wherein the volume normalization coefficient calculating unit detects, from a first spectrum peak which is a spectrum peak of audio included in one content to be composited and a second spectrum peak which is a spectrum peak of audio included in another one content to be composited, a first and second spectrum peak which are at close positions, as common peaks which are peaks of the same or similar audio signal components;

and wherein a predetermined multiple, which minimizes error between the first spectrum peak and the second spectrum peak multiplied by the predetermined multiple, that have been detected as the common peaks, is calculated as the volume normalization coefficient.

[7]

The information processing device according to [1], further including:

an optimal volume ratio calculating unit configured to estimate a part of audio included in the content to be composited, and obtain an optimal volume ratio for the content to be composited based on the part;

wherein the compositing unit composites audio included in the content to be composited while adjusting volume in accordance with the volume ratio.

[8]

The information processing device according to [7],

Wherein the optimal volume ratio calculating unit estimates a part of audio included in a content to be composited from metadata of the content to be composited.

[9]

The information processing device according to [7], wherein the optimal volume ratio calculating unit estimates, from audio included in the content to be composited, whether or not a part of audio included in the content to be composited is a vocal part, based on basic frequency of suppressed audio where the same or similar audio signal component has been suppressed.

[10]

The information processing device according to [7], wherein the optimal volume ratio calculating unit obtains the volume ratio such that the difference in volume between the audio of the vocal part and the audio of a non-vocal part which is a part other than the vocal part is a predetermined value or greater.

[11]

The information processing device according to [7], wherein the optimal volume ratio calculating unit obtains the volume ratio by referencing a database where information relating to volume of each part of audio in a concerted form has been registered.

[12]

The information processing device according to any one of [1] through [11], wherein the synchronization information generating unit obtains a lag, where a coefficient of cross-correlation of audio feature amounts of two contents is greatest, as synchronization information to synchronize the two contents.

[13]

The information processing device according to [12], further including:

a synchronization able/unable determining unit configured to determine whether or not the two contents include the same or similar audio signal components and can be synchronized, based on the greatest value of the coefficient of cross-correlation; and

a content selecting unit configured to select two or more contents including the same or similar audio signal components, as content to be composited which are to be composited as to the composited content, in response to user operations;

wherein the compositing unit composites the content to be composited as to the composited content.

[14]

An information processing method, including:

feature amount calculating to obtain an audio feature amount of audio included in a content including audio;

synchronization information generating to generate synchronization information for synchronizing a plurality of contents including the same or similar audio signal components, based on the audio feature amount obtained in the feature amount calculating; and

compositing to generate composited content, where a plurality of contents have been synchronized and composited using the synchronization information generated in the synchronization information generating.

[15]

A program causing a computer to function as:

a feature amount calculating unit configured to obtain an audio feature amount of audio included in a content including audio;

a synchronization information generating unit configured to generate synchronization information for synchronizing a plurality of contents including the same or similar audio signal components, based on the audio feature amount obtained by the feature amount calculating unit; and

a compositing unit configured to generate composited content, where a plurality of contents have been synchronized and composited using the synchronization information generated at the synchronization information generating unit.

[16]

A recording medium in which is recorded a program causing a computer to function as:

a feature amount calculating unit configured to obtain an audio feature amount of audio included in a content including audio;

a synchronization information generating unit configured to generate synchronization information for synchronizing a plurality of contents including the same or similar audio signal components, based on the audio feature amount obtained by the feature amount calculating unit; and

a compositing unit configured to generate composited content, where a plurality of contents have been synchronized and composited using the synchronization information generated at the synchronization information generating unit.

[17]

An information processing system, including:

a client; and

a server configured to communicate with the client;

wherein the server includes, of
a feature amount calculating unit configured to obtain an audio feature amount of audio included in a content including audio,
a synchronization information generating unit configured to generate synchronization information for synchronizing a plurality of contents including the same or similar audio signal components, based on the audio feature amount obtained by the feature amount calculating unit, and
   a compositing unit configured to generate composited content, where a plurality of contents have been synchronized and composited using the synchronization information generated at the synchronization information generating unit,

at least the synchronization information generating unit,

and wherein the client includes the remainder of the feature amount calculating unit, the synchronization information generating unit, and the compositing unit.

[18]

An information processing method, wherein a server of an information processing system including

a client, and

a server configured to communicate with the client,

performs, of
feature amount calculating to obtain an audio feature amount of audio included in a content including audio,
synchronization information generating to generate synchronization information for synchronizing a plurality of contents including the same or similar audio signal components, based on the audio feature amount obtained in the feature amount calculating, and
compositing to generate composited content, where a plurality of contents have been synchronized and composited using the synchronization information generated in the synchronization information generating,

at least the synchronization information generating,

and wherein the client performs the remainder of the feature amount calculating, the synchronization information generating, and the compositing.

The present disclosure contains subject matter related to that disclosed in Japanese Priority Patent Application JP 2011-283817 filed in the Japan Patent Office on Dec. 26, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device, comprising:
a feature amount calculating unit configured to obtain an audio feature amount of audio included in a content including audio;
a synchronization information generating unit configured to generate synchronization information for synchronizing a plurality of contents including the same or similar audio signal components, based on the audio feature amount obtained by the feature amount calculating unit; and
a compositing unit configured to generate composited content, where a plurality of contents have been synchronized and composited using the synchronization information generated at the synchronization information generating unit.

2. The information processing device according to claim 1, wherein the compositing unit performs compositing of audio included in the contents to be composited, with the same or similar audio signal components suppressed.

3. The information processing device according to claim 1, wherein the content to be composited include images;
and wherein the compositing unit extracts subjects included in images from the contents to be composited, and composites as to a predetermined background.

4. The information processing device according to claim 1, wherein the content to be composited include images;
and wherein the compositing unit
composites, in accordance with positioning information indicating positioning of images, images included in the content to be composited in a positioning indicated by the positioning information, and
provides localization to audio included in the contents to be composited, following the positioning information, and composites the audio with the localization provided thereto.

5. The information processing device according to claim 1, further comprising:
a volume normalization coefficient calculating unit configured to calculate a volume normalization coefficient to change volume of each of the contents to be composited, such that the levels of the same or similar audio signals components included in the contents to be composited match;
wherein the compositing unit composites audio included in the content to be composited while adjusting audio in accordance with the volume normalization coefficient.

6. The information processing device according to claim 5, wherein the volume normalization coefficient calculating unit detects, from a first spectrum peak which is a spectrum peak of audio included in one content to be composited and a second spectrum peak which is a spectrum peak of audio included in another one content to be composited, a first and second spectrum peak which are at close positions, as common peaks which are peaks of the same or similar audio signal components;
and wherein a predetermined multiple, which minimizes error between the first spectrum peak and the second spectrum peak multiplied by the predetermined multiple, that have been detected as the common peaks, is calculated as the volume normalization coefficient.

7. The information processing device according to claim 1, further comprising:
an optimal volume ratio calculating unit configured to estimate a part of audio included in the content to be composited, and obtain an optimal volume ratio for the content to be composited based on the part;
wherein the compositing unit composites audio included in the content to be composited while adjusting volume in accordance with the volume ratio.

8. The information processing device according to claim 7,
wherein the optimal volume ratio calculating unit estimates a part of audio included in a content to be composited from metadata of the content to be composited.

9. The information processing device according to claim 7, wherein the optimal volume ratio calculating unit estimates, from audio included in the content to be composited, whether or not a part of audio included in the content to be composited is a vocal part, based on basic frequency of suppressed audio where the same or similar audio signal component has been suppressed.

10. The information processing device according to claim 7, wherein the optimal volume ratio calculating unit obtains the volume ratio such that the difference in volume between the audio of the vocal part and the audio of a non-vocal part which is a part other than the vocal part is a predetermined value or greater.

11. The information processing device according to claim 7, wherein the optimal volume ratio calculating unit obtains the volume ratio by referencing a database where information relating to volume of each part of audio in a concerted form has been registered.

12. The information processing device according to claim 1, wherein the synchronization information generating unit obtains a lag, where a coefficient of cross-correlation of audio feature amounts of two contents is greatest, as synchronization information to synchronize the two contents.

13. The information processing device according to claim 12, further comprising:
a synchronization able/unable determining unit configured to determine whether or not the two contents include the same or similar audio signal components and can be synchronized, based on the greatest value of the coefficient of cross-correlation; and
a content selecting unit configured to select two or more contents including the same or similar audio signal components, as content to be composited which are to be composited as to the composited content, in response to user operations;
wherein the compositing unit composites the content to be composited as to the composited content.

14. An information processing method, comprising:
a feature amount calculating step arranged to obtain an audio feature amount of audio included in a content including audio;
a synchronization information generating step arranged to generate synchronization information for synchronizing a plurality of contents including the same or similar audio signal components, based on the audio feature amount obtained in the feature amount calculating step; and
a compositing step arranged to generate composited content, where a plurality of contents have been synchronized and composited using the synchronization information generated in the synchronization information generating step.

15. A program causing a computer to function as:
a feature amount calculating unit configured to obtain an audio feature amount of audio included in a content including audio;
a synchronization information generating unit configured to generate synchronization information for synchronizing a plurality of contents including the same or similar audio signal components, based on the audio feature amount obtained by the feature amount calculating unit; and
a compositing unit configured to generate composited content, where a plurality of contents have been synchronized and composited using the synchronization information generated at the synchronization information generating unit.

16. A recording medium in which is recorded a program causing a computer to function as:
a feature amount calculating unit configured to obtain an audio feature amount of audio included in a content including audio;
a synchronization information generating unit configured to generate synchronization information for synchronizing a plurality of contents including the same or similar audio signal components, based on the audio feature amount obtained by the feature amount calculating unit; and
a compositing unit configured to generate composited content, where a plurality of contents have been synchronized and composited using the synchronization information generated at the synchronization information generating unit.

17. An information processing system, comprising:
a client; and
a server configured to communicate with the client;
wherein the server includes, of
a feature amount calculating unit configured to obtain an audio feature amount of audio included in a content including audio,
a synchronization information generating unit configured to generate synchronization information for synchronizing a plurality of contents including the same or similar audio signal components, based on the audio feature amount obtained by the feature amount calculating unit, and
a compositing unit configured to generate composited content, where a plurality of contents have been synchronized and composited using the synchronization information generated at the synchronization information generating unit,
at least the synchronization information generating unit,
and wherein the client includes the remainder of the feature amount calculating unit, the synchronization information generating unit, and the compositing unit.

18. An information processing method, wherein a server of an information processing system including
a client, and
a server configured to communicate with the client, performs, of
a feature amount calculating step arranged to obtain an audio feature amount of audio included in a content including audio,
a synchronization information generating step arranged to generate synchronization information for synchronizing a plurality of contents including the same or similar audio signal components, based on the audio feature amount obtained in the feature amount calculating step, and
a compositing step arranged to generate composited content, where a plurality of contents have been synchronized and composited using the synchronization information generated in the synchronization information generating step,
at least the synchronization information generating step,
and wherein the client performs the remainder of the feature amount calculating step, the synchronization information generating step, and the compositing step.
